(19) United States
(12) Patent Application Publication
(10) Pub. No.: US 2025/0259340 A1
(43) Pub. Date: Aug. 14, 2025

(54) LEARNING CONTINUOUS CONTROL FOR 3D-AWARE IMAGE GENERATION ON TEXT-TO-IMAGE DIFFUSION MODELS

(71) Applicant: ADOBE INC., SAN JOSE, CA (US)

(72) Inventors: Ta-Ying Cheng, Oxford (GB); Matheus Gadelha, San Jose, CA (US); Thibault Hervé Sébastien Groueix, San Francisco, CA (US); Matthew David Fisher, Burlingame, CA (US); Radomir Mech, Los Altos, CA (US)

(21) Appl. No.: 18/439,157

(22) Filed: Feb. 12, 2024

(51) Int. Cl. G06T 11/00; G06F 40/284; G06T 17/00

(52) U.S. Cl. CPC G06T 11/00; G06F 40/284; G06T 17/00

(57) ABSTRACT

A method, apparatus, non-transitory computer readable medium, and system for image processing include obtaining a text prompt describing an element and an attribute value for a continuous attribute of the element, embedding the text prompt to obtain a text embedding in a text embedding space, embedding the attribute value to obtain an attribute embedding in the text embedding space, and generating a synthetic image based on the text embedding and the attribute embedding, where the synthetic image depicts the continuous attribute of the element based on the attribute value.

### BACKGROUND

The following relates generally to image processing, and more specifically to image generation using a machine learning model. Image processing refers to the use of a computer to edit an image using an algorithm or a processing network. In some cases, image processing software can be used for various image processing tasks, such as image restoration, image detection, image compositing, image editing, and image generation. For example, image generation includes the use of the machine learning model to generate an image based on a text prompt.

In some cases, image generation models may be used to generate images that have the appearance of depth. That is, two-dimensional (2D) images can have the appearance of three-dimensional (3D) attributes such as depth or perspective.

### SUMMARY

Aspects of the present disclosure provide methods, non-transitory computer readable media, apparatuses, and systems for image processing. Aspects of the present disclosure include a continuous control model trained to generate an attribute embedding based on an input attribute. In one aspect, the input attribute includes a 3-dimensional characteristic of an element described by a text prompt. In some aspects, a text embedding model generates a text embedding based on the text prompt. In some aspects, the text embedding and the attribute embedding are combined as an input embedding to a text encoder to generate a guidance embedding for an image generation model. The image generation model generates a synthetic image based on the guidance feature, where the synthetic image includes the element described by the text prompt and depicts the continuous attribute of the element based on the attribute value.

A method, apparatus, non-transitory computer readable medium, and system for image processing include obtaining a text prompt describing an element and an attribute value for a continuous attribute of the element, embedding the text prompt to obtain a text embedding in a text embedding space, embedding, using a continuous control model, the attribute value to obtain an attribute embedding in the text embedding space, and generating, using an image generation model, a synthetic image based on the text embedding and the attribute embedding, where the synthetic image depicts the continuous attribute of the element based on the attribute value.

A method, apparatus, non-transitory computer readable medium, and system for image processing include initializing a machine learning model, obtaining a training set including a plurality of training images depicting an object with a plurality of values of a continuous attribute, respectively, training, using the training set, an image generation model to generate synthetic images with the plurality of values of the continuous attribute, and training, using the training set, a continuous control model to generate an input for the image generation model corresponding to the continuous attribute.

An apparatus and system for image processing include at least one processor, at least one memory storing instructions executable by the at least one processor, a continuous control model comprising parameters stored in the at least one memory and trained to embed an attribute value of a continuous attribute to obtain an attribute embedding in a text embedding space, and an image generation model comprising parameters stored in the at least one memory and trained to generate a synthetic image based on a text embedding of a text prompt and the attribute embedding, where the synthetic image depicts the continuous attribute based on the attribute value.

### BRIEF DESCRIPTION OF THE DRAWINGS

FIG. 1 shows an example of an image processing system according to aspects of the present disclosure.

FIG. 2 shows an example of a method for text-to-image generation according to aspects of the present disclosure.

FIGS. 3 and 4 show examples of a mixed-text to image generation according to aspects of the present disclosure.

FIG. 5 shows an example of an image interpolation using an attribute value according to aspects of the present disclosure.

FIG. 6 shows an example of a method for generating a synthetic image based on a text prompt according to aspects of the present disclosure.

FIG. 7 shows an example of an image processing apparatus according to aspects of the present disclosure.

FIG. 8 shows an example of a machine learning model according to aspects of the present disclosure.

FIG. 9 shows an example of a diffusion model according to aspects of the present disclosure.

FIG. 10 shows an example of a method for generating a synthetic image based on an embedding according to aspects of the present disclosure.

FIG. 11 shows an example of a method for training a machine learning model according to aspects of the present disclosure.

FIG. 12 shows an example of a first stage training according to aspects of the present disclosure.

FIG. 13 shows an example of a second stage training according to aspects of the present disclosure.

FIG. 14 shows an example of a computing device according to aspects of the present disclosure.

### DETAILED DESCRIPTION

Aspects of the present disclosure provide methods, non-transitory computer readable media, apparatuses, and systems for image processing. Aspects of the present disclosure include a continuous control model trained to generate an attribute embedding based on an input attribute. In one aspect, the input attribute includes a 3-dimensional characteristic of an element described by a text prompt. In some aspects, a text embedding model generates a text embedding based on the text prompt. In some aspects, the text embedding and the attribute embedding are combined as an input embedding to a text encoder to generate a guidance embedding for an image generation model. The image generation model generates a synthetic image based on the guidance feature, where the synthetic image includes the element described by the text prompt and depicts the continuous attribute of the element based on the attribute value.

According to some aspects, the input attribute includes a 3-dimensional characteristic of the element described by the text prompt. For example, the input attribute includes orientation, illumination direction, non-rigid shape transformation, zoom effect, or object poses of the element. However, expressing these 3-dimensional characteristics in text descriptions is challenging and laborious. According to some aspects, the input attribute is integrated into a user control to allow a user to easily control a value of the input attribute of the element to be generated in the synthetic image.

A subfield in image processing relates to text-to-image generation. Text-to-image generation models are capable of generating 2D images that closely resemble authentic photographs. However, the text inputs used to generate these 2D images are inherently limited to high-level descriptions, which are far removed from the detailed controls over actual photography. In some cases, conventional models are trained with limited datasets, for example, limited descriptions of a training image with the precise object movements and camera parameters. In some cases, training images can be rendered with predefined camera parameters, object movements, or non-rigid shape transformations at a fine-grained scale. However, generating these training images can be inefficient and computationally burdensome.

Conventional text-to-image generation models use large-scale text-image datasets to guide the image generation process. In some cases, conventional models utilize memory-efficient strategies by incorporating latent-space diffusion methods for enhanced performance. In some cases, conventional models use zero-convolution for conditioning on text and image data (e.g., depth map, canny map, and sketch). However, these conventional models fail to control attributes of an element depicted in the image, such as illumination direction or object orientation.

In some cases, conventional models first generate an image conditioned based on a text input and then perform edits using textual instructions. For example, a user can edit the generated image by amending the text prompt while preserving some aspects of the original image. However, conventional approaches are limited in detailed control over an element depicted in the image because of the limitation on the user's ability to describe the characteristics of the element through text. For example, describing a change in the illumination direction by an angle of 11° in a 3-dimensional space would pose a considerable challenge.

In some cases, conventional models can be trained on 3D data of an element (e.g., various viewpoints of a 3D rendering). The conventional models enable viewpoint editing given the image depicting the element. In some cases, conventional models rely on extensive 3D datasets to perform edits to an object orientation of the element depicted in the image. However, these edits are performed in a post-processing stage (for example, performing edits to the generated image). As a result, conventional models are inefficient in generating synthetic images having controllable 3-dimensional characteristics.

Accordingly, the present disclosure describes a method and a system that generates a synthetic image depicting a desired attribute of an element based on a continuous attribute input including an attribute value and a text prompt describing the element. In one aspect, the text prompt and the continuous attribute input are combined and input into an image generation model to generate the synthetic image. In one aspect, the continuous attribute input includes a 3-dimensional characteristic of the element such as orientation, illumination direction, non-rigid shape transformation, object pose, zoom effect, etc. In one aspect, the continuous attribute input is integrated into a user control of a user interface that allows a user to easily input a desired attribute to generate the synthetic image. In one aspect, the continuous attribute input includes a variable input instead of a specific value.

According to some aspects, the image generation model is trained using a two-stage training process. The first training stage is to train the image generation model to learn the identity of an element described by the text prompt. For example, the image generation model generates a synthetic image based on a training image depicting an element and the text prompt describing the element. The image generation model is then fine-tuned using a reconstruction loss computed based on the training image and the synthetic image. By fine-tuning the image generation model in the first stage using the reconstruction loss, the image generation model can learn the identity of the element described by the text prompt.

According to some aspects, the second training stage is to train the image generation model to learn the attribute of the element based on the continuous attribute input and the text prompt. For example, a continuous control model receives the continuous attribute input to generate an attribute embedding. The attribute embedding is combined with a text embedding of the text prompt to generate an input embedding for the image generation model. The image generation model generates a synthetic image based on the training image and the input embedding. In one aspect, the training image depicts the element and includes an attribute of the continuous attribute input. The image generation model is fine-tuned using a reconstruction loss computed based on the training image and the synthetic image. By fine-tuning the image generation model in the second stage using the reconstruction loss, the image generation model can learn the attribute of the element from the continuous attribute input.

According to some aspects, the continuous control model is trained to generate an attribute embedding based on the attribute value. For example, the continuous control model includes a multilayer perceptron (MLP). In one aspect, the MLP is able to receive a continuous input or an input (e.g., the attribute input) and generate a continuous output (e.g., the attribute embedding). Accordingly, the continuous control model can generate an attribute embedding based on an attribute value for a continuous attribute input, where the attribute embedding is used as input to the image generation model.

According to some aspects, the image generation model is configured to generate the synthetic image based on a negative prompt. In one aspect, the negative prompt is used to guide the image generation model away from generating the element described by the negative prompt. For example, the negative prompt includes elements depicted in the training images. By generating the synthetic image using the negative prompt, the image generation model can be generalized on new, unseen data.

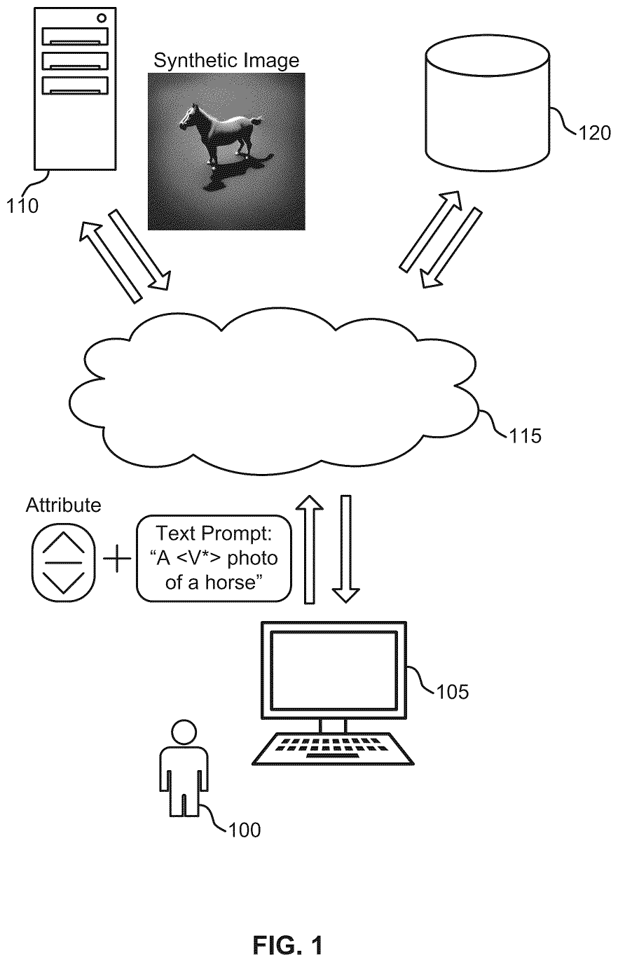

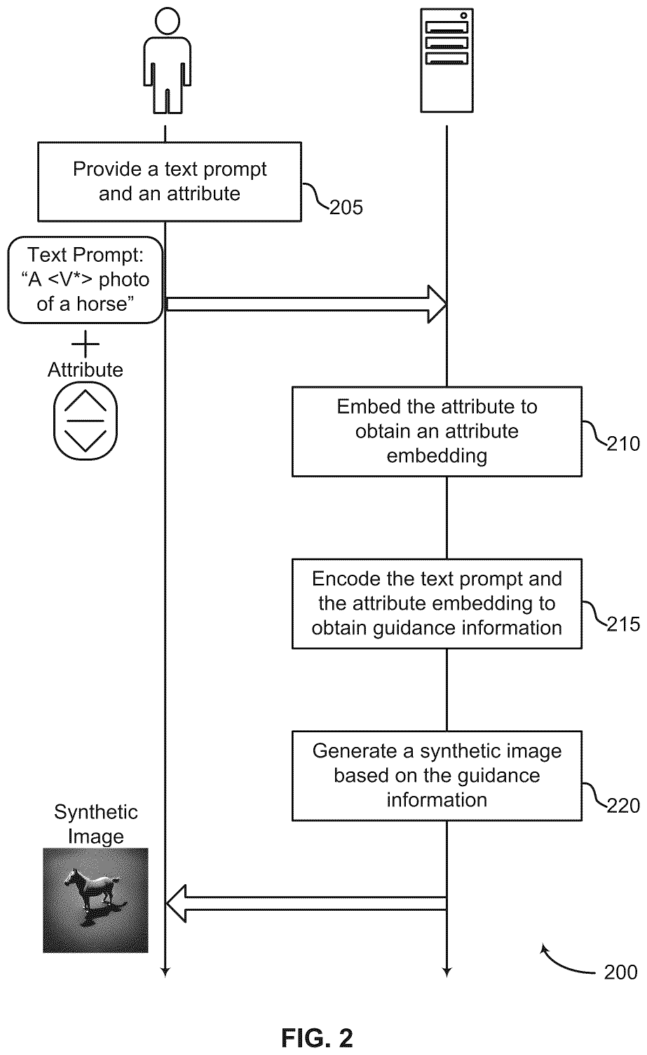

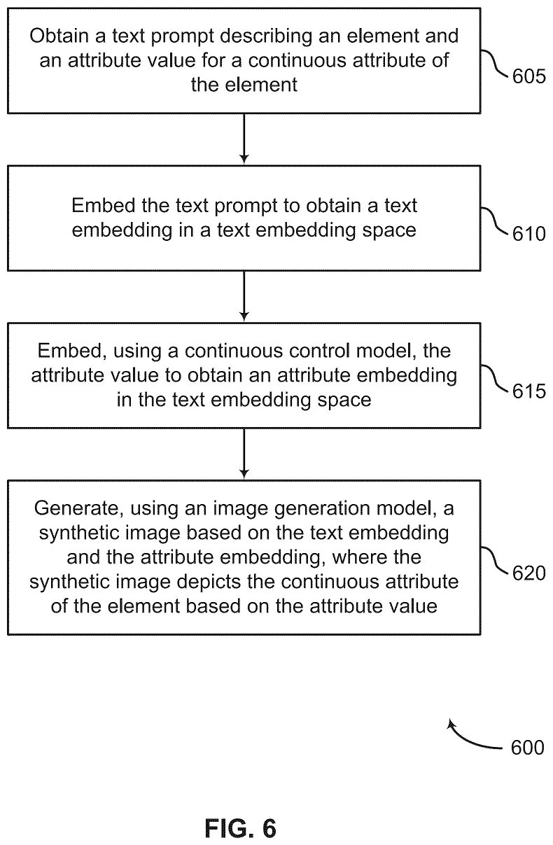

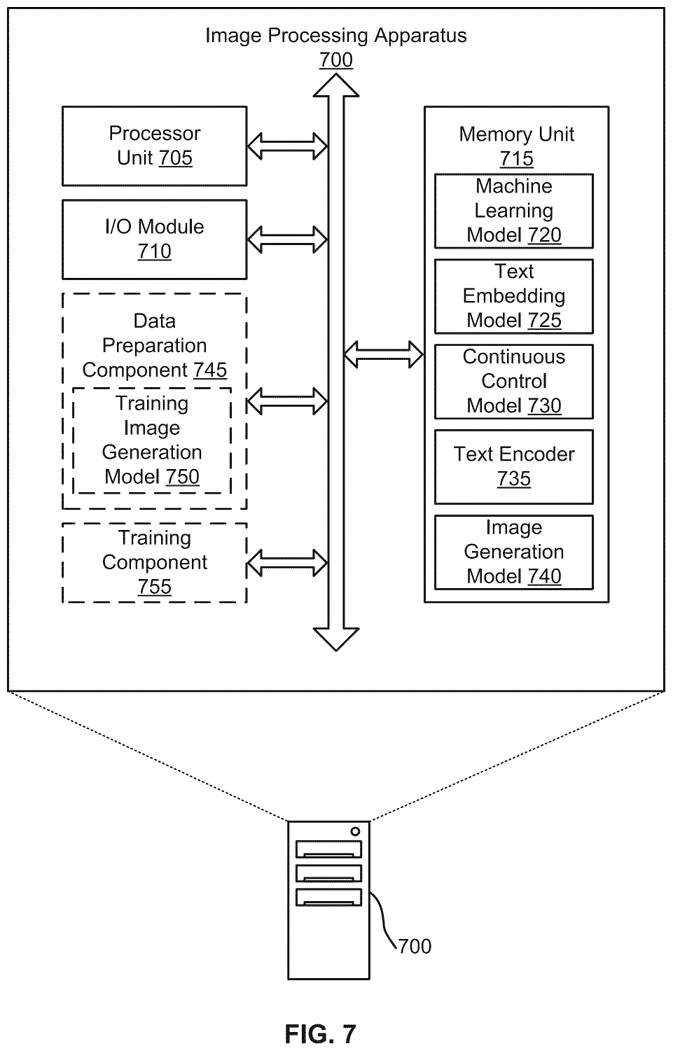

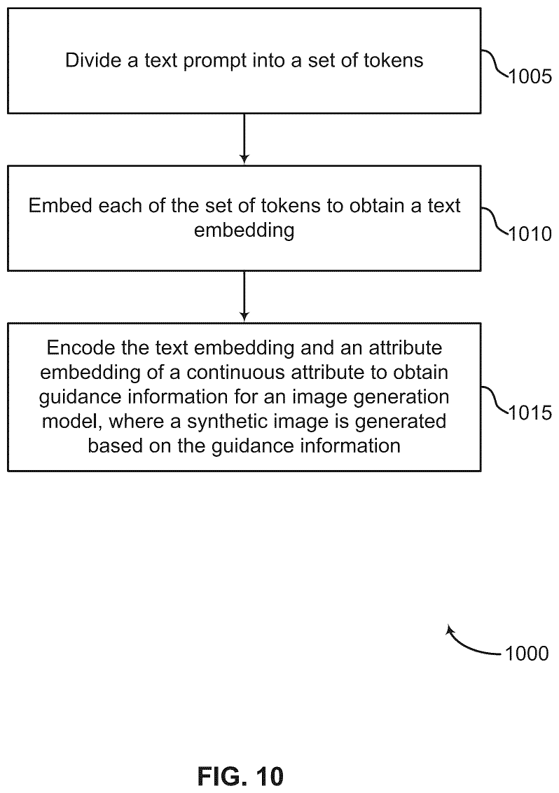

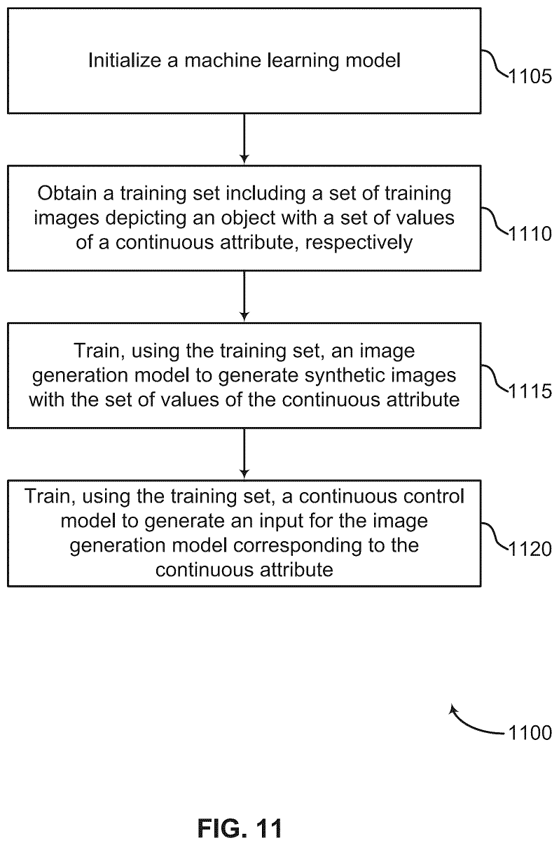

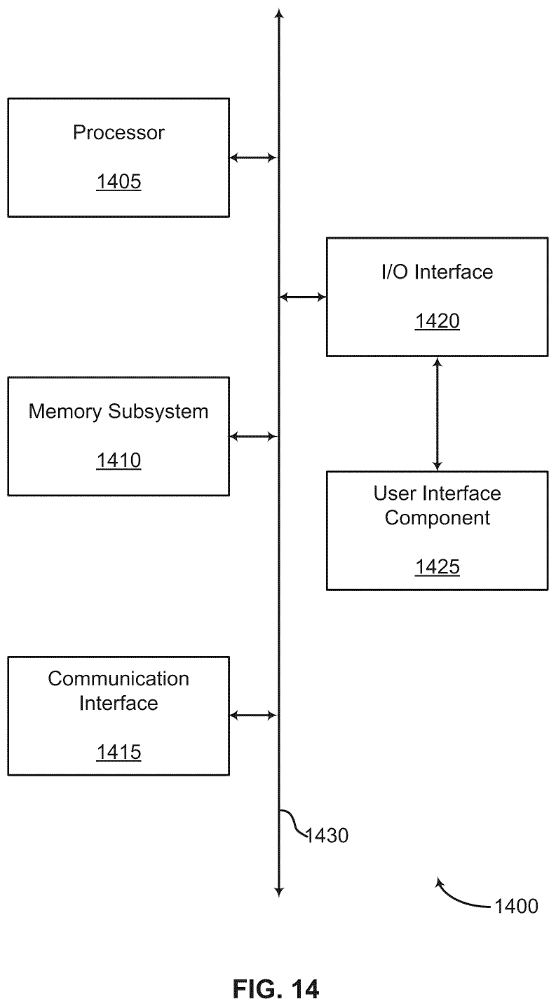

An example system of the inventive concept in image processing is provided with reference to FIGS. 1 and 14. An example application of the inventive concept in image processing is provided with reference to FIGS. 2-5. Details regarding the architecture of an image processing apparatus are provided with reference to FIGS. 7-9. An example of a process for image processing is provided with reference to FIGS. 6 and 10. A description of an example training process is provided with reference to FIGS. 11-13.

Embodiments of the present disclosure include systems and methods that improve on conventional image generation models by generating more accurate synthetic images given a target continuous attribute, including 3D attributes such as camera perspective and lighting conditions. For example, an image generation model may be trained to generate a synthetic image with a target perspective based on a text prompt describing the object and an input specifying the target attribute. The improved accuracy may be achieved by training an attribute encoder (i.e., a continuous control model) that converts a continuous attribute into a text embedding space. Furthermore, by combining the output of a continuous control model with a text prompt, the image generation model can generate synthetic images with a target continuous characteristic more efficiently (i.e., in a single generation process).

In some examples, the image generation model is trained using a two-stage training process. For example, the first training stage enables the image generation model to learn the modify attributes (i.e., a pose or perspective) of a particular object. The second training stage enables the image generation model to learn the continuous attribute of the element from the continuous attribute input. Accordingly, by training the image generation using the two-stage training process, the image generation model is able to disentangle attributes from object identity and thus enhance the quality of image generation.

### Image Processing

In FIGS. 1-6 and 10, a method, apparatus, non-transitory computer readable medium, and system for image processing include obtaining a text prompt describing an element and an attribute value for a continuous attribute of the element, embedding the text prompt to obtain a text embedding in a text embedding space, embedding, using a continuous control model, the attribute value to obtain an attribute embedding in the text embedding space, and generating, using an image generation model, a synthetic image based on the text embedding and the attribute embedding. In some cases, the synthetic image depicts the continuous attribute of the element based on the attribute value.

In some aspects, the continuous attribute comprises a 3-dimensional characteristic of the element. Some examples of the method, apparatus, non-transitory computer readable medium, and system further include dividing the text prompt into a plurality of tokens. Some examples further include embedding each of the plurality of tokens using a text embedding model. In some aspects, the text prompt includes a nonce token corresponding to the attribute value. In some aspects, the text prompt includes a word corresponding to the continuous attribute.

Some examples of the method, apparatus, non-transitory computer readable medium, and system further include encoding the text embedding and the attribute embedding to obtain guidance information for the image generation model. In some cases, the synthetic image is generated based on the guidance information. Some examples of the method, apparatus, non-transitory computer readable medium, and system further include performing a diffusion process on a noise input to obtain the synthetic image.

In some aspects, the image generation model is trained using a training set including a plurality of training images depicting an object with a plurality of values of the continuous attribute, respectively. Some examples of the method, apparatus, non-transitory computer readable medium, and system further include identifying a negative prompt based on the object from the plurality of training images. In some cases, the synthetic image is generated based on the negative prompt.

Some examples of the method, apparatus, non-transitory computer readable medium, and system further include obtaining an additional attribute value corresponding to an additional continuous attribute. In some cases, the synthetic image is generated to depict the additional attribute value.

Some examples of the method, apparatus, non-transitory computer readable medium, and system further include obtaining a plurality of attribute values for the continuous attribute. Some examples further include generating, using the image generation model, a plurality of synthetic images based on a same random input and the plurality of attribute values, respectively.

FIG. 1 shows an example of an image processing system according to aspects of the present disclosure. The example shown includes user 100, user device 105, image processing apparatus 110, cloud 115, and database 120. Image processing apparatus 110 is an example of, or includes aspects of, the corresponding element described with reference to FIG. 7.

Referring to FIG. 1, user 100 provides a text prompt describing an element and an attribute to image processing apparatus 110 via user device 105 and cloud 115. For example, the text prompt states “A photo of a horse.” In some cases, the text prompt includes a nonce token that corresponds to the attribute. For example, the text prompt states “A<V*> photo of a horse,” where <V*> represents the nonce token. In some cases, one or more attributes are provided to image processing apparatus 110. For example, the attribute includes a 3-dimensional characteristic of the element. In some cases, for example, the attribute includes 3-dimensional orientation or 3-dimensional illumination of the element, such as the horse, described by the text prompt. In some cases, the attribute is integrated into a user control of a user interface, where a value of the attribute can be easily modified using the user control. Image processing apparatus 110 generates a synthetic image based on the text prompt and the attribute. For example, the synthetic image depicts a horse described by the text prompt and a 3-dimensional orientation and/or a 3-dimensional illumination based on the attribute. In some cases, image processing apparatus 110 displays the synthetic image to user 100 via user device 105 and cloud 115.

User device 105 may be a personal computer, laptop computer, mainframe computer, palmtop computer, personal assistant, mobile device, or any other suitable processing apparatus. In some examples, user device 105 includes software that incorporates an image processing application. In some examples, the image processing application on user device 105 may include functions of image processing apparatus 110.

A user interface may enable user 100 to interact with user device 105. In some embodiments, the user interface may include an audio device, such as an external speaker system, an external display device such as a display screen, or an input device (e.g., a remote-controlled device interfaced with the user interface directly or through an I/O controller module). In some cases, a user interface may be a graphical user interface (GUI). In some examples, a user interface may be represented in code in which the code is sent to the user device 105 and rendered locally by a browser. The process of using the image processing apparatus 110 is further described with reference to FIG. 2.

Image processing apparatus 110 is an example of, or includes aspects of, the corresponding element described with reference to FIG. 7. According to some aspects, image processing apparatus 110 includes a computer implemented network comprising a machine learning model, a text embedding model, a continuous control model, a text encoder, and an image generation model. Image processing apparatus 110 further includes a processor unit, a memory unit, an I/O module, a training component, and a data preparation component. In some cases, the data preparation component includes a training image generation model. In some embodiments, image processing apparatus 110 further includes a communication interface, user interface components, and a bus as described with reference to FIG. 14. Additionally, image processing apparatus 110 communicates with user device 105 and database 120 via cloud 115. Further detail regarding the operation of image processing apparatus 110 is provided with reference to FIG. 2.

In some cases, image processing apparatus 110 is implemented on a server. A server provides one or more functions to users linked by way of one or more of the various networks. In some cases, the server includes a single microprocessor board, which includes a microprocessor responsible for controlling aspects of the server. In some cases, a server uses the microprocessor and protocols to exchange data with other devices/users on one or more of the networks via hypertext transfer protocol (HTTP), and simple mail transfer protocol (SMTP), although other protocols such as file transfer protocol (FTP), and simple network management protocol (SNMP) may also be used. In some cases, a server is configured to send and receive hypertext markup language (HTML) formatted files (e.g., for displaying web pages). In various embodiments, a server comprises a general-purpose computing device, a personal computer, a laptop computer, a mainframe computer, a supercomputer, or any other suitable processing apparatus.

Cloud 115 is a computer network configured to provide on-demand availability of computer system resources, such as data storage and computing power. In some examples, cloud 115 provides resources without active management by the user (e.g., user 100). The term cloud is sometimes used to describe data centers available to many users over the Internet. Some large cloud networks have functions distributed over multiple locations from central servers. A server is designated an edge server if the server has a direct or close connection to a user. In some cases, cloud 115 is limited to a single organization. In other examples, cloud 115 is available to many organizations. In one example, cloud 115 includes a multi-layer communications network comprising multiple edge routers and core routers. In another example, cloud 115 is based on a local collection of switches in a single physical location.

According to some aspects, database 120 stores training data (or training set) including a plurality of training images depicting an object with a plurality of values of a continuous attribute. Database 120 is an organized collection of data. For example, database 120 stores data in a specified format known as a schema. Database 120 may be structured as a single database, a distributed database, multiple distributed databases, or an emergency backup database. In some cases, a database controller may manage data storage and processing in database 120. In some cases, a user (e.g., user 100) interacts with the database controller. In other cases, the database controller may operate automatically without user interaction.

FIG. 2 shows an example of a method 200 for text-to-image generation according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

Referring to FIG. 2, a user (e.g., the user described with reference to FIG. 1) provides a text prompt and an attribute to the image processing apparatus (e.g., the image processing apparatus described with reference to FIGS. 1 and 7). For example, the text prompt states “A<V*> photo of a horse.” In some cases, the nonce token <V*> is added to the text prompt by the machine learning model. In some cases, the nonce token <V*> is not displayed to the user and is processed by the machine learning model. In some cases, the nonce token <V*> is replaced by the attribute. The attribute describes a 3-dimensional characteristic of the object described by the text prompt. For example, the attribute describes the orientation, illumination, pose, and zoom. The image processing apparatus generates a text embedding based on the text prompt and generates an attribute embedding based on the attribute. In some cases, the text embedding and the attribute embedding are combined to generate an input embedding to a text encoder of the machine learning model. The text encoder generates a guidance embedding based on the input embedding to guide an image generation model to generate a synthetic image. The synthetic image depicts a horse described by the text prompt and a 3-dimensional characteristic based on the attribute.

At operation 205, the system provides a text prompt and an attribute. In some cases, the operations of this step refer to, or may be performed by, a user as described with reference to FIG. 1. For example, the user provides a text prompt “A photo of a horse” and an attribute to the image processing apparatus via a user interface provided by the image processing apparatus on a user device (e.g., the user device described with reference to FIG. 1). In some cases, for example, the attribute is integrated into a user control, where the attribute can be easily modified by the user. In some cases, the attribute includes 3-dimensional characteristics (such as orientation, pose, and illumination) of the element described by the text prompt.

At operation 210, the system embeds the attribute to obtain an attribute embedding. In some cases, the operations of this step refer to, or may be performed by, an image processing apparatus as described with reference to FIGS. 1 and 7. In some cases, the operations of this step refer to, or may be performed by, a continuous control model as described with reference to FIGS. 7, 8, and 13. In some cases, for example, the continuous control model includes a multilayer perceptron (MLP) trained to embed the attribute to obtain the attribute embedding. In some cases, the machine learning model embeds the text prompt to obtain a text embedding. In some cases, the attribute embedding is added to a region of a sequence of the text embedding.

At operation 215, the system encodes the text prompt and the attribute embedding to obtain guidance information. In some cases, the operations of this step refer to, or may be performed by, an image processing apparatus as described with reference to FIGS. 1 and 7. In some cases, the operations of this step refer to, or may be performed by, a text encoder as described with reference to FIGS. 7-9. In some embodiments, the text encoder receives the text embedding (including the attribute embedding) to generate a guidance embedding (e.g., guidance information). The guidance embedding is used to guide the image generation model to generate a synthetic image.

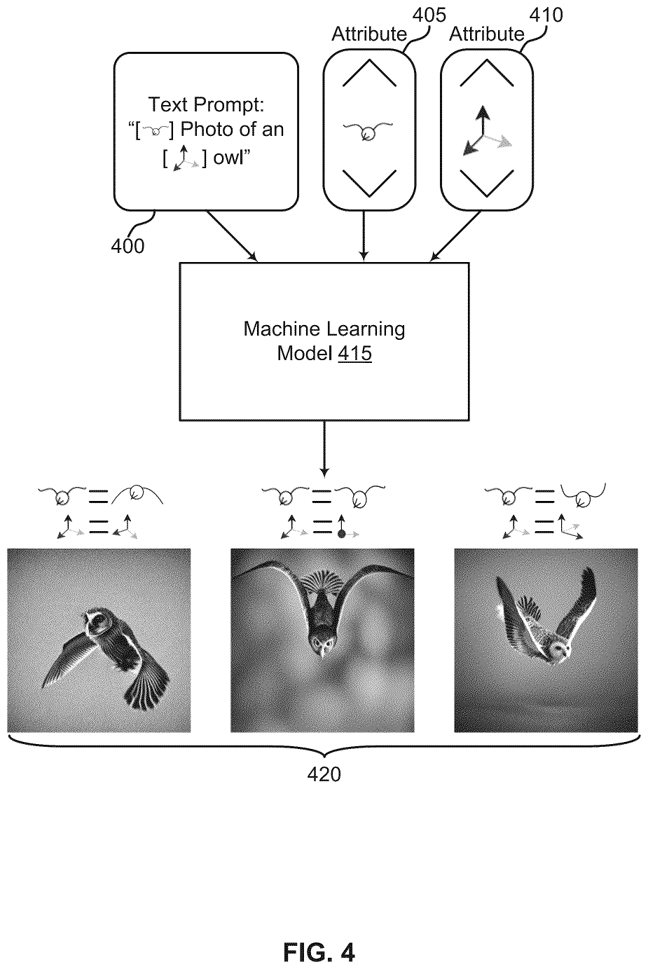

At operation 220, the system generates a synthetic image based on the guidance information. In some cases, the operations of this step refer to, or may be performed by, an image processing apparatus as described with reference to FIGS. 1 and 7. In some cases, the operations of this step refer to, or may be performed by, an image generation model as described with reference to FIGS. 4, 7, 8, 12, and 13. In some embodiments, the image generation model receives a noise input (e.g., a noise map) and the guidance embedding to generate the synthetic image. In some cases, the synthetic image includes the element described by the text prompt and the attribute from the user input. In some cases, the synthetic image is displayed on a user device via a user interface of the image processing apparatus and cloud.

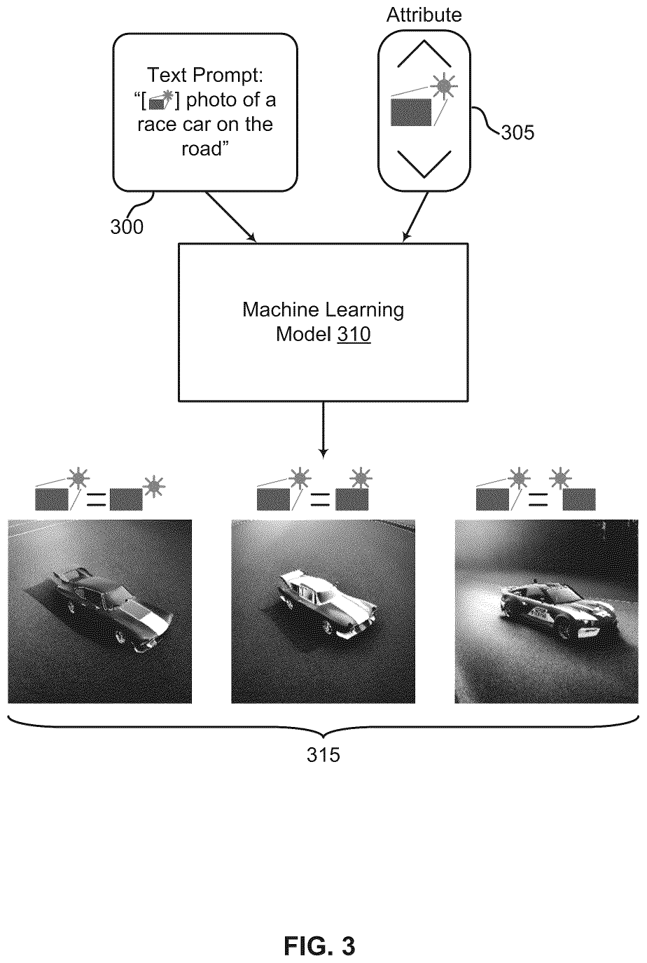

FIG. 3 shows an example of a mixed-text to image generation according to aspects of the present disclosure. The example shown includes text prompt 300, attribute 305, machine learning model 310, and synthetic image 315. In some embodiments, the example shown is integrated into a user interface.

Referring to FIG. 3, machine learning model 310 receives text prompt 300 and attribute 305 to generate synthetic image 315. For example, text prompt 300 states “photo of a race car on the road.” In some cases, text prompt 300 includes a placeholder for attribute 305. For example, attribute 305 can be placed in the beginning, middle, or end of text prompt 300. Attribute 305 includes a 3-dimensional characteristic of the element described by text prompt 300. For example, attribute 305 includes illumination direction. In some embodiments, attribute 305 is integrated into a user control in a user interface, where a user can easily modify an attribute value of attribute 305. For example, the user control may include scrollbars, buttons, text input controls, dropdown lists, sliders, progress bars, switches, tabs, dropdown menus, etc.

In some cases, synthetic image 315 includes one or more synthetic images depicting the element described by text prompt 300 and a 3-dimensional characteristic from attribute 305. For example, synthetic image 315 on the left depicts a car (i.e., the element described by text prompt 300) and an illumination direction (i.e., the 3-dimensional characteristic from attribute 305) specified by, for example, the user. In some cases, the illumination direction is depicted by the shadow of the car. For example, the illumination direction shows that the light source is at the upper right-hand corner of the element. As a result, the shadow is reflected on the opposite side of the light source, for example, the bottom left-hand corner of the element. Synthetic image 315 in the middle depicts a car (e.g., a different car) and a second illumination direction. Synthetic image 315 on the right depicts a car (e.g., a different car) and a third illumination direction.

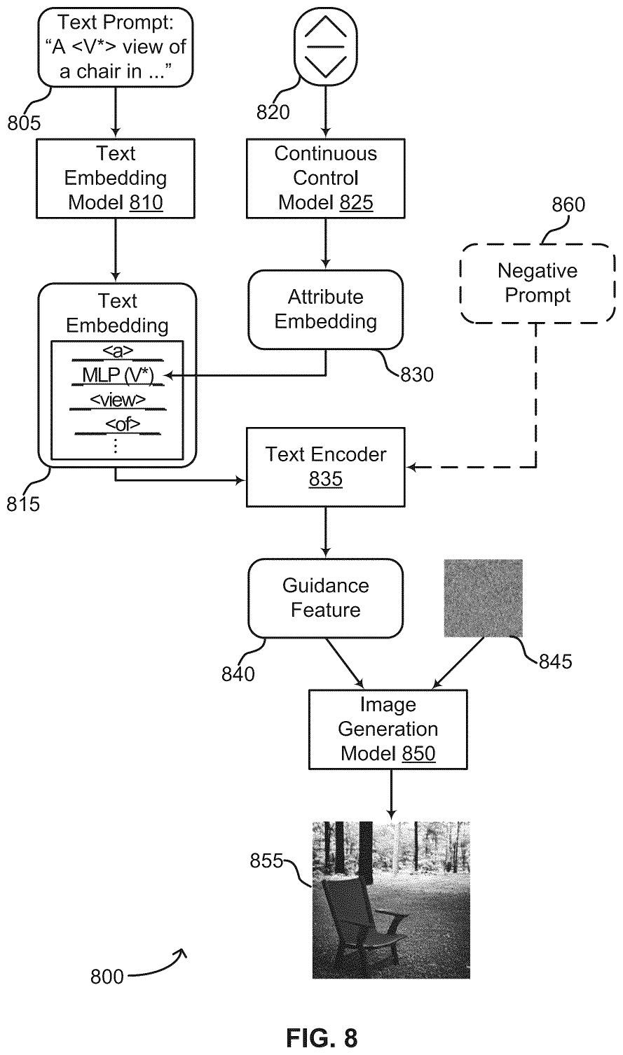

Text prompt 300 is an example of, or includes aspects of, the corresponding element described with reference to FIGS. 4, 5, 8, 9, 12, and 13. Attribute 305 is an example of, or includes aspects of, the corresponding element described with reference to FIGS. 8, 12, and 13. Machine learning model 310 is an example of, or includes aspects of, the corresponding element described with reference to FIGS. 4, 5, 7, 8, 12, and 13. Synthetic image 315 is an example of, or includes aspects of, the corresponding element described with reference to FIGS. 4, 8, 12, and 13.

FIG. 4 shows an example of a mixed-text to image generation according to aspects of the present disclosure. The example shown includes text prompt 400, first attribute 405, second attribute 410, machine learning model 415, and synthetic image 420. In some embodiments, the example shown is integrated into a user interface.

Referring to FIG. 4, machine learning model 415 receives text prompt 400, first attribute 405, and second attribute 410 to generate synthetic image 420. For example, text prompt 400 states “Photo of an owl.” In some cases, text prompt 400 includes placeholders for first attribute 405 and second attribute 410. For example, first attribute 405 and second attribute 410 can be placed in the beginning, middle, or end of text prompt 400. In some embodiments, first attribute 405 and second attribute 410 are integrated into a single user control. In some embodiments, first attribute 405 and second attribute 410 are integrated into two different user controls. First attribute 405 includes the wing pose of the element. Second attribute 410 includes the 3-dimensional orientation of the element.

In some cases, synthetic image 420 includes one or more synthetic images depicting the element described by text prompt 400 and 3-dimensional characteristics from first attribute 405 and second attribute 410. For example, synthetic image 420 on the left depicts an owl (i.e., the element described by text prompt 400), a wing pose (i.e., the 3-dimensional characteristic from first attribute 405), and a 3-dimensional orientation (i.e., the 3-dimensional characteristic from second attribute 410) specified by, for example, the user. Synthetic image 420 on the left, middle, and right depicts different combinations of first attribute 405 and second attribute 410. For example, synthetic image 420 on the left depicts a first wing pose and a first 3-dimensional orientation, synthetic image 420 in the middle depicts a second wing pose and a second 3-dimensional orientation, and synthetic image 420 on the right depicts a third wing pose and a third 3-dimensional orientation. In some cases, machine learning model 415 can generate synthetic image 420 having first attribute 405 fixed and second attribute 410 changed, or vice versa. For example, synthetic image 420 on the left may depict a first wing pose and a first 3-dimensional orientation, synthetic image 420 in the middle may depict a first wing pose and a second 3-dimensional orientation, and synthetic image 420 on the right may depict a first wing pose and a third 3-dimensional orientation.

Text prompt 400 is an example of, or includes aspects of, the corresponding element described with reference to FIGS. 3, 5, 8, 9, 12, and 13. Machine learning model 415 is an example of, or includes aspects of, the corresponding element described with reference to FIGS. 3, 4, 7, 8, 12, and 13. Synthetic image 420 is an example of, or includes aspects of, the corresponding element described with reference to FIGS. 3, 8, 12, and 13.

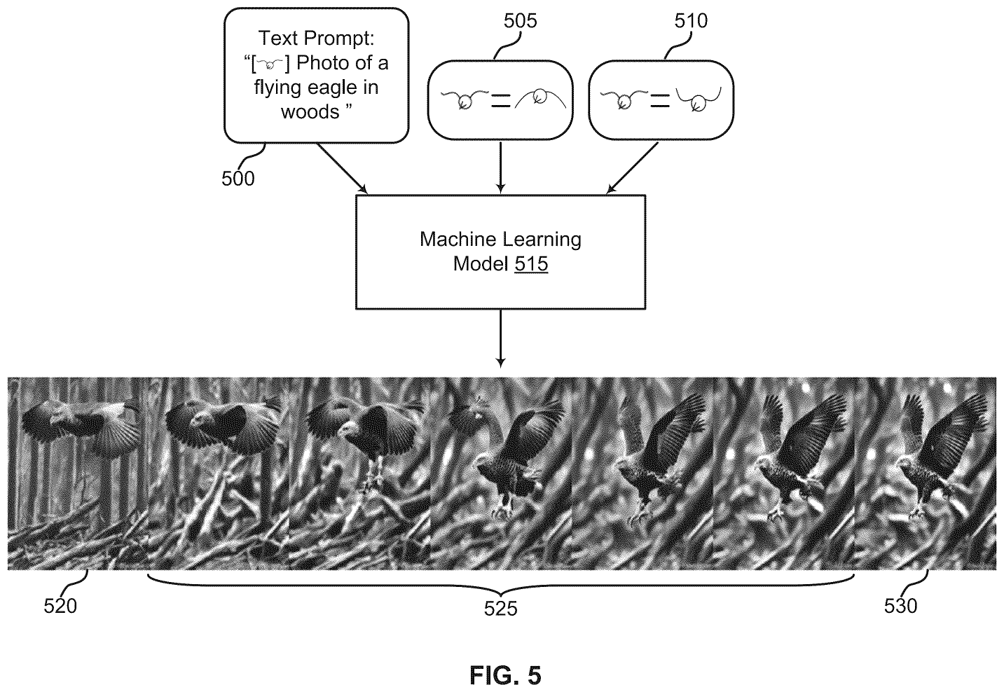

FIG. 5 shows an example of an image interpolation using an attribute value according to aspects of the present disclosure. The example shown includes text prompt 500, first attribute value 505, second attribute value 510, machine learning model 515, first synthetic image 520, intermediate synthetic images 525, and final synthetic image 530. In some embodiments, the example shown is integrated into a user interface.

Referring to FIG. 5, machine learning model 515 receives text prompt 500, first attribute value 505, and second attribute value 510 to generate a plurality of synthetic images (e.g., first synthetic image 520, intermediate synthetic images 525, and final synthetic image 530). For example, text prompt 500 states “Photo of a flying eagle in woods.” In some embodiments, first attribute value 505 and second attribute value 510 are part of the same attribute integrated into a single user control. For example, first attribute value 505 includes a first information of an attribute (e.g., wing pose). Second attribute value 510 includes a second information of the same attribute. For example, first attribute value 505 and second attribute value 510 represent the shape/location of the wing pose of the owl (e.g., the element described by text prompt 500). For example, first attribute value 505 represents the wing pose in a downward direction and second attribute value 510 represents the wing pose in an upward direction.

Machine learning model 515 generates first synthetic image 520 and final synthetic image 530 based on first attribute value 505 and second attribute value 510, respectively. Additionally, machine learning model 515 generates intermediate synthetic images 525 by interpolating wing pose information based on first attribute value 505 and second attribute value 510. For example, machine learning model 515 may generate a plurality of intermediate attribute values based on the first attribute value 505 and second attribute value 510, where intermediate synthetic images 525 are generated based on the plurality of intermediate attribute values, respectively. In one aspect, each of the plurality of synthetic images (e.g., first synthetic image 520, intermediate synthetic images 525, and final synthetic image 530) depicts the same owl (e.g., the element described by text prompt 500) but with changing wing poses. In one aspect, the visual change of the wing pose is continuous and dynamic.

Text prompt 500 is an example of, or includes aspects of, the corresponding element described with reference to FIGS. 3, 4, 8, 9, 12, and 13. Machine learning model 515 is an example of, or includes aspects of, the corresponding element described with reference to FIGS. 3, 4, 7, 8, 12, and 13. First synthetic image 520, intermediate synthetic images 525, and final synthetic image 530 are examples of, or include aspects of, the synthetic image described with reference to FIGS. 3, 4, 8, 12, and 13.

FIG. 6 shows an example of a method 600 for generating a synthetic image based on a text prompt according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 605, the system obtains a text prompt describing an element and an attribute value for a continuous attribute of the element. In some cases, the operations of this step refer to, or may be performed by, a machine learning model as described with reference to FIGS. 3, 5, 7, 8, 12, and 13. In some cases, a user provides the text prompt and the attribute value to the machine learning model of the image generation system. For example, the text prompt describes a dog and the attribute value includes attribute information of the dog, such as orientation.

The continuous attribute, such orientation of an object or an apparent camera view of the scene can be difficult to describe precisely using text. For example, it can include one or more numerical parameters such as distance and angle (e.g., the distance between an object and the viewpoint, or angles describing the relationship between an object and a light source). Accordingly, these parameters can be provided separately from the text. For example, a user can move one or more slider or other UI elements to adjust an object orientation, a view, a pose, or a lighting position. The attribute can be described in terms of one or more continuous variables such as 3D position coordinates, Euler angles, or orientation angles such as yaw, pitch and roll.

In some aspects, for example, the text prompt can be short, long, or compound. For example, the text prompt may describe one or more elements or objects. In some cases, an element includes an object (e.g., a chair, table, or book), a feature (e.g., shadow, lighting, or color), a category (e.g., photo, image, or sketch), etc. In some cases, an attribute value may include information that can be understood by a computing device. For example, the attribute value may include a value, a natural language, a shape, a coordinate, a data point, etc. In some cases, continuous attribute includes a 3-dimensional characteristic of the element. For example, a continuous attribute may include a 3-dimensional orientation, illumination direction, non-rigid shape transformation, object pose, zoom effect, etc. In some cases, the continuous attribute may include 2-dimensional characteristics of the element, such as edges, contours, color intensity, etc. In one aspect, the continuous attribute includes a variable 3-dimensional characteristic of the element described by the text prompt. For example, the variable 3-dimensional characteristic include a range of values or a value that can be changed.

At operation 610, the system embeds the text prompt to obtain a text embedding in a text embedding space. In some cases, the operations of this step refer to, or may be performed by, a text embedding model as described with reference to FIGS. 7 and 8. In some cases, the text prompt is divided into a plurality of tokens, where the text embedding is based on the plurality of tokens. In some cases, the text prompt includes a nonce token corresponding to the continuous attribute. In some cases, the text prompt includes a word corresponding to the continuous attribute. In some cases, the text embedding may be represented in the form of a table, where each cell of the text embedding represents a word token of the text prompt.

According to some aspects, the text embedding model generates the text embedding based on the text prompt. In one aspect, an embedding (such as text embedding, image embedding, or guidance embedding) refers to a numerical representation of words, sentences, documents, or images in a vector space. The embedding is used to encode semantic meaning, relationships, and context of the words, sentences, documents, or images where the encoding can be processed by a machine learning model.

In one aspect, an embedding space refers to the space formed by vectors (e.g., embeddings) representing data points (e.g., text prompts). Vector space provides a framework for representing and manipulating data (in the form of vectors), computing distances between vectors, and transforming input data for complex relationships. The dimensionality of the vector space is determined by the number of features in the feature vector. For example, if each data point has three features (e.g., length, width, and height), the vector space is three-dimensional. In some cases, a joint vector space includes a high-dimensional vector space and a low-dimensional vector space. In some cases, an image embedding is in a high-dimensional vector space and a text embedding is in a low-dimensional vector space.

In one aspect, text tokens or tokens refer to a meaningful unit of a natural language. Tokenization is the process of breaking down a sequence of text into individual tokens. In some cases, tokens can be words, sub-words, or characters. For example, a word token represents each individual word in the text. The sub-word token represents a further breakdown of the word. For example, if the word is “individual”, the sub-word tokens may be “indi” and “vidual”. Character token is the breakdown of a word in the text into individual characters. For example, character tokens for the word “token” are “t”, “o”, “k”, “e”, and “n”. Tokenization allows the machine learning model to understand, process, analyze, or classify data that includes texts.

In one aspect, a nonce token refers to a placeholder token that can be added to a text or text prompt. For example, the nonce token may be represented by a symbol, shape, or letter. The nonce token may be placed in a specific location of the text prompt. The value of the nonce token may be a variable rather than a specific value.

At operation 615, the system embeds, using a continuous control model, the attribute value to obtain an attribute embedding in the text embedding space. In some cases, the operations of this step refer to, or may be performed by, a continuous control model as described with reference to FIGS. 7, 8, and 13. For example, the continuous control model includes a multilayer perceptron (MLP), where the MLP is able to receive a continuous input (e.g., the attribute value) and generate a continuous output (e.g., the attribute embedding). In some cases, the attribute embedding of the attribute value is combined with the text embedding of the text prompt as input to the image generation model. For example, the attribute embedding is added to a region of a sequence of the text embedding.

In some examples, the attribute embedding can be used as a token and combined with tokens from the text in the same embedding space. Although the attributes can be difficult to describe using words, the text embedding space can have sufficient parameters to represent them accurately. In some cases, these tokens are further processed in combination. For example, a transformer may be used to encode contextual information within individual tokens, or to generate an individual embedding that represents the text and the attribute embedding combined. The combined text and attribute embedding can be used as an input to an image generation model.

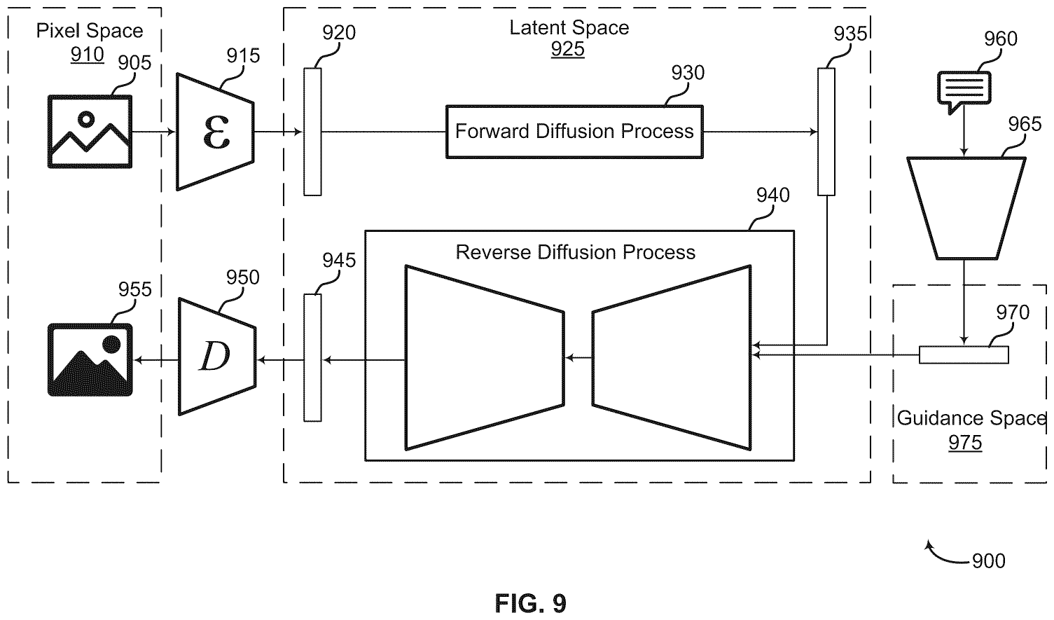

At operation 620, the system generates, using an image generation model, a synthetic image based on the text embedding and the attribute embedding, where the synthetic image depicts the continuous attribute of the element based on the attribute value. In some cases, the operations of this step refer to, or may be performed by, an image generation model as described with reference to FIGS. 4, 7, 8, 12, and 13. For example, the image generation model receives the text embedding (including the attribute embedding) and a noise input (e.g., a noise map) to generate the synthetic image. In some cases, the image generation model includes a diffusion model. The diffusion model is an example of, or includes aspects of, the corresponding element described with reference to FIG. 9.

### System Architecture

In FIGS. 1, 7-9, and 14, an apparatus and system for image processing include at least one processor, at least one memory storing instructions executable by the at least one processor, a continuous control model comprising parameters stored in the at least one memory and trained to embed an attribute value of a continuous attribute to obtain an attribute embedding in a text embedding space, and an image generation model comprising parameters stored in the at least one memory and trained to generate a synthetic image based on a text embedding of a text prompt and the attribute embedding, where the synthetic image depicts the continuous attribute based on the attribute value.

Some examples of the apparatus and system further include a text encoder comprising parameters stored in the at least one memory and configured to encode the text embedding and the attribute embedding to obtain guidance information for the image generation model. In some aspects, the continuous control model comprises a multilayer perceptron (MLP). In some aspects, the image generation model comprises a diffusion model.

FIG. 7 shows an example of an image processing apparatus 700 according to aspects of the present disclosure. The example shown includes image processing apparatus 700, processor unit 705, I/O module 710, memory unit 715, data preparation component 745, and training component 755. In one aspect, memory unit 715 includes machine learning model 720, text embedding model 725, continuous control model 730, text encoder 735, and image generation model 740. In one aspect, data preparation component 745 includes training image generation model 750.

According to some embodiments of the present disclosure, image processing apparatus 700 includes a computer-implemented artificial neural network (ANN). An ANN is a hardware or a software component that includes a number of connected nodes (e.g., artificial neurons), which loosely correspond to the neurons in a human brain. Each connection, or edge, transmits a signal from one node to another (like the physical synapses in a brain). When a node receives a signal, the node processes the signal and then transmits the processed signal to other connected nodes. In some cases, the signals between nodes comprise real numbers, and the output of each node is computed by a function of the sum of its inputs. In some examples, nodes may determine the output using other mathematical algorithms (e.g., selecting the max from the inputs as the output) or any other suitable algorithm for activating the node. Each node and edge is associated with one or more node weights that determine how the signal is processed and transmitted. Image processing apparatus 700 is an example of, or includes aspects of, the corresponding element described with reference to FIG. 1.

Processor unit 705 is an intelligent hardware device, (e.g., a general-purpose processing component, a digital signal processor (DSP), a central processing unit (CPU), a graphics processing unit (GPU), a microcontroller, an application-specific integrated circuit (ASIC), a field programmable gate array (FPGA), a programmable logic device, a discrete gate or transistor logic component, a discrete hardware component, or any combination thereof). In some cases, processor unit 705 is configured to operate a memory array using a memory controller. In other cases, a memory controller is integrated into the processor. In some cases, processor unit 705 is configured to execute computer-readable instructions stored in a memory to perform various functions. In some embodiments, processor unit 705 includes special-purpose components for modem processing, baseband processing, digital signal processing, or transmission processing. Processor unit 705 is an example of, or includes aspects of, the processor described with reference to FIG. 14.

I/O module 710 (e.g., an input/output interface) may include an I/O controller. An I/O controller may manage input and output signals for a device. I/O controller may also manage peripherals not integrated into a device. In some cases, an I/O controller may represent a physical connection or port to an external peripheral. In some cases, an I/O controller may utilize an operating system such as iOS®, ANDROID®, MS-DOS®, MS-WINDOWS®, OS/2®, UNIX®, LINUX®, or another known operating system. In other cases, an I/O controller may represent or interact with a modem, a keyboard, a mouse, a touchscreen, or a similar device. In some cases, an I/O controller may be implemented as part of a processor. In some cases, a user may interact with a device via an I/O controller or via hardware components controlled by an I/O controller.

In some examples, I/O module 710 includes a user interface. A user interface may enable a user to interact with a device. In some embodiments, the user interface may include an audio device, such as an external speaker system, an external display device such as a display screen, or an input device (e.g., a remote control device interfaced with the user interface directly or through an I/O controller module). In some cases, a user interface may be a graphical user interface (GUI). In some examples, a communication interface operates at the boundary between communicating entities and the channel and may also record and process communications. A communication interface is provided herein to enable a processing system coupled to a transceiver (e.g., a transmitter and/or a receiver). In some examples, the transceiver is configured to transmit (or send) and receive signals for a communications device via an antenna. I/O module 710 is an example of, or includes aspects of, the I/O interface described with reference to FIG. 14. The user interface is an example of, or includes aspects of, the corresponding element described with reference to FIGS. 1, 3, 4, 5, and 14.

Examples of memory unit 715 include random access memory (RAM), read-only memory (ROM), or a hard disk. Examples of memory unit 715 include solid-state memory and a hard disk drive. In some examples, memory unit 715 is used to store computer-readable, computer-executable software including instructions that, when executed, cause a processor to perform various functions described herein.

In some cases, memory unit 715 includes, among other things, a basic input/output system (BIOS) that controls basic hardware or software operations such as the interaction with peripheral components or devices. In some cases, a memory controller operates memory cells. For example, the memory controller can include a row decoder, column decoder, or both. In some cases, memory cells within memory unit 715 store information in the form of a logical state.

In one aspect, memory unit 715 includes machine learning model 720, text embedding model 725, continuous control model 730, text encoder 735, and image generation model 740. Memory unit 715 is an example, of, or includes aspects of, the memory subsystem described with reference to FIG. 14.

According to some aspects, machine learning model 720 includes text embedding model 725, continuous control model 730, text encoder 735, and image generation model 740. In some cases, machine learning model 720 is a computational algorithm, model, or system designed to recognize patterns, make predictions, or perform a specific task (for example, image processing) without being explicitly programmed. According to some aspects, machine learning model 720 is implemented as software stored in memory unit 715 and executable by processor unit 705, as firmware, as one or more hardware circuits, or as a combination thereof.

According to some embodiments of the present disclosure, machine learning model 720 includes an ANN, which is a hardware or a software component that includes a number of connected nodes (e.g., artificial neurons), which loosely correspond to the neurons in a human brain. Each connection, or edge, transmits a signal from one node to another (like the physical synapses in a brain). When a node receives a signal, the node processes the signal and then transmits the processed signal to other connected nodes. In some cases, the signals between nodes comprise real numbers, and the output of each node is computed by a function of the sum of its inputs. In some examples, nodes may determine the output using other mathematical algorithms (e.g., selecting the max from the inputs as the output) or any other suitable algorithm for activating the node. Each node and edge is associated with one or more node weights that determine how the signal is processed and transmitted.

During the training process, the one or more node weights are adjusted to increase the accuracy of the result (e.g., by minimizing a loss function that corresponds in some way to the difference between the current result and the target result). The weight of an edge increases or decreases the strength of the signal transmitted between nodes. In some cases, nodes have a threshold below which a signal is not transmitted at all. In some examples, the nodes are aggregated into layers. Different layers perform different transformations on the corresponding inputs. The initial layer is known as the input layer and the last layer is known as the output layer. In some cases, signals traverse certain layers multiple times.

According to some embodiments, machine learning model 720 includes a computer-implemented convolutional neural network (CNN). CNN is a class of neural networks commonly used in computer vision or image classification systems. In some cases, a CNN may enable processing of digital images with minimal pre-processing. A CNN may be characterized by the use of convolutional (or cross-correlational) hidden layers. These layers apply a convolution operation to the input before signaling the result to the next layer. Each convolutional node may process data for a limited field of input (e.g., the receptive field). During a forward pass of the CNN, filters at each layer may be convolved across the input volume, computing the dot product between the filter and the input. During the training process, the filters may be modified so that the filters activate when the filters detect a particular feature within the input.

In one aspect, machine learning model 720 includes machine learning parameters. Machine learning parameters, also known as model parameters or weights, are variables that provide behavior and characteristics of machine learning model 720. Machine learning parameters can be learned or estimated from training data and are used to make predictions or perform tasks based on learned patterns and relationships in the data.

Machine learning parameters are adjusted during a training process to minimize a loss function or maximize a performance metric. The goal of the training process is to find optimal values for the parameters that allow machine learning model 720 to make accurate predictions or perform well on the given task.

For example, during the training process, an algorithm adjusts machine learning parameters to minimize an error or loss between predicted outputs and actual targets according to optimization techniques like gradient descent, stochastic gradient descent, or other optimization algorithms. Once the machine learning parameters are learned from the training data, the machine learning parameters are used to make predictions on new, unseen data.

According to some embodiments, machine learning model 720 includes a computer-implemented recurrent neural network (RNN). An RNN is a class of ANN in which connections between nodes form a directed graph along an ordered (e.g., a temporal) sequence. This enables an RNN to model temporally dynamic behavior such as predicting what element should come next in a sequence. Thus, an RNN is suitable for tasks that involve ordered sequences such as text recognition (where words are ordered in a sentence). In some cases, an RNN includes one or more finite impulse recurrent networks (characterized by nodes forming a directed acyclic graph), one or more infinite impulse recurrent networks (characterized by nodes forming a directed cyclic graph), or a combination thereof.

According to some embodiments, machine learning model 720 includes a transformer (or a transformer model, or a transformer network), where the transformer is a type of neural network model used for natural language processing tasks. A transformer network transforms one sequence into another sequence using an encoder and a decoder. The encoder and decoder include modules that can be stacked on top of each other multiple times. The modules comprise multi-head attention and feed-forward layers. The inputs and outputs (target sentences) are first embedded into an n-dimensional space. Positional encoding of the different words (e.g., give each word/part in a sequence a relative position since the sequence depends on the order of its elements) is added to the embedded representation (n-dimensional vector) of each word. In some examples, a transformer network includes an attention mechanism, where the attention looks at an input sequence and decides at each step which other parts of the sequence are important. The attention mechanism involves a query, keys, and values denoted by Q, K, and V, respectively. Q is a matrix that contains the query (vector representation of one word in the sequence), K are the keys (vector representations of the words in the sequence) and V are the values, which are again the vector representations of the words in the sequence. For the encoder and decoder, multi-head attention modules, V consists of the same word sequence as Q. However, for the attention module that takes into account the encoder and the decoder sequences, V is different from the sequence represented by Q. In some cases, values in V are multiplied and summed with some attention-weights a.

In the machine learning field, an attention mechanism (e.g., implemented in one or more ANNs) is a method of placing differing levels of importance on different elements of an input. Calculating attention may involve three basic steps. First, a similarity between the query and key vectors obtained from the input is computed to generate attention weights. Similarity functions used for this process can include the dot product, splice, detector, and the like. Next, a softmax function is used to normalize the attention weights. Finally, the attention weights are weighed together with the corresponding values. In the context of an attention network, the key and value are vectors or matrices that are used to represent the input data. The key is used to determine which parts of the input the attention mechanism should focus on, while the value is used to represent the actual data being processed.

An attention mechanism is a key component in some ANN architectures, particularly ANNs employed in natural language processing (NLP) and sequence-to-sequence tasks, that allows an ANN to focus on different parts of an input sequence when making predictions or generating output. Some sequence models (such as RNNs) process an input sequence sequentially, maintaining an internal hidden state that captures information from previous steps. However, in some cases, this sequential processing leads to difficulties in capturing long-range dependencies or attending to specific parts of the input sequence.

The attention mechanism addresses these difficulties by enabling an ANN to selectively focus on different parts of an input sequence, assigning varying degrees of importance or attention to each part. The attention mechanism achieves the selective focus by considering a relevance of each input element with respect to a current state of the ANN.

The term “self-attention” refers to a machine learning model in which representations of the input interact with each other to determine attention weights for the input. Self-attention can be distinguished from other attention models because the attention weights are determined at least in part by the input itself.

According to some aspects, machine learning model 720 obtains a text prompt describing an element and an attribute value for a continuous attribute of the element. In some aspects, the continuous attribute includes a 3-dimensional characteristic of the element. In some aspects, the text prompt includes a nonce token corresponding to the attribute value. In some aspects, the text prompt includes a word corresponding to the continuous attribute.

In some examples, machine learning model 720 identifies a negative prompt based on the object from the set of training images, where the synthetic image is generated based on the negative prompt. In some examples, machine learning model 720 obtains an additional attribute value corresponding to an additional continuous attribute, where the synthetic image is generated to depict the additional attribute value. In some examples, machine learning model 720 obtains a set of attribute values for the continuous attribute. Machine learning model 720 is an example of, or includes aspects of, the corresponding element described with reference to FIGS. 3, 4, 5, 8, 12, and 13.

According to some aspects, text embedding model 725 is implemented as software stored in memory unit 715 and executable by processor unit 705, as firmware, as one or more hardware circuits, or as a combination thereof. According to some aspects, text embedding model 725 embeds the text prompt to obtain a text embedding in a text embedding space. In some examples, text embedding model 725 divides the text prompt into a set of tokens. In some examples, text embedding model 725 embeds each of the set of tokens using a text embedding model 725. Text embedding model 725 is an example of, or includes aspects of, the corresponding element described with reference to FIG. 8.

According to some aspects, continuous control model 730 is implemented as software stored in memory unit 715 and executable by processor unit 705, as firmware, as one or more hardware circuits, or as a combination thereof. According to some aspects, continuous control model 730 embeds, using a continuous control model 730, the attribute value to obtain an attribute embedding in the text embedding space.

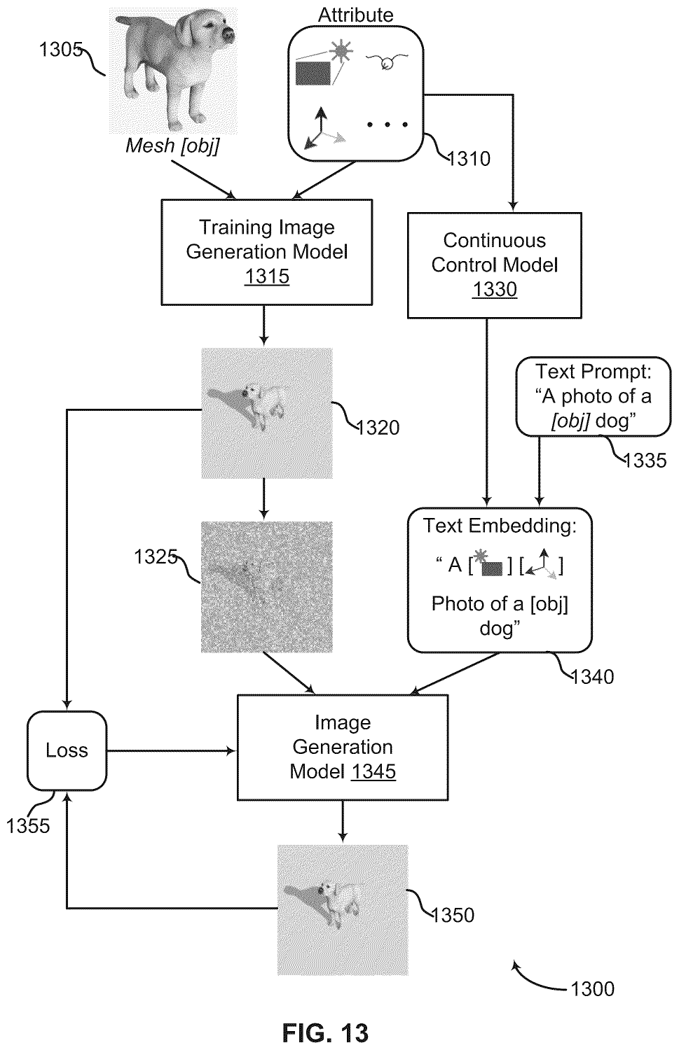

According to some aspects, continuous control model 730 comprises parameters stored in the at least one memory and trained to embed an attribute value of a continuous attribute to obtain an attribute embedding in a text embedding space. In some aspects, the continuous control model 730 includes a multilayer perceptron (MLP). Continuous control model 730 is an example of, or includes aspects of, the corresponding element described with reference to FIGS. 8 and 13.

According to some aspects, text encoder 735 is implemented as software stored in memory unit 715 and executable by processor unit 705, as firmware, as one or more hardware circuits, or as a combination thereof. According to some aspects, text encoder 735 encodes the text embedding and the attribute embedding to obtain guidance information for the image generation model 740, where the synthetic image is generated based on the guidance information.

According to some aspects, text encoder 735 comprises parameters stored in the at least one memory and configured to encode the text embedding and the attribute embedding to obtain guidance information for the image generation model 740. Text encoder 735 is an example of, or includes aspects of, the corresponding element described with reference to FIGS. 8 and 9.

According to some aspects, image generation model 740 is implemented as software stored in memory unit 715 and executable by processor unit 705, as firmware, as one or more hardware circuits, or as a combination thereof. According to some aspects, image generation model 740 generates a synthetic image based on the text embedding and the attribute embedding, where the synthetic image depicts the continuous attribute of the element based on the attribute value. In some examples, image generation model 740 performs a diffusion process on a noise input to obtain the synthetic image.

In some aspects, the image generation model 740 is trained using a training set including a set of training images depicting an object with a set of values of the continuous attribute, respectively. In some examples, image generation model 740 generates a set of synthetic images based on a same random input and the set of attribute values, respectively. In some aspects, the image generation model 740 is trained individually in a first stage. In some aspects, the image generation model 740 is trained together with the continuous control model 730 in a second stage.

According to some aspects, image generation model 740 comprises parameters stored in the at least one memory and trained to generate a synthetic image based on a text embedding of a text prompt and the attribute embedding, wherein the synthetic image depicts the continuous attribute based on the attribute value. In some aspects, the image generation model 740 includes a diffusion model. Image generation model 740 is an example of, or includes aspects of, the corresponding element described with reference to FIGS. 4, 8, 12, and 13.

According to some aspects, data preparation component 745 is implemented as software stored in memory unit 715 and executable by processor unit 705, as firmware, as one or more hardware circuits, or as a combination thereof. According to some embodiments, data preparation component 745 is implemented as software stored in a memory unit and executable by a processor in a processor unit of a separate computing device, as firmware in a separate computing device, as one or more hardware circuits of the separate computing device, or as a combination thereof. In some examples, data preparation component 745 is part of another apparatus other than image processing apparatus 700 and communicates with the image processing apparatus 700. In some examples, data preparation component 745 is part of image processing apparatus 700.

According to some aspects, data preparation component 745 includes training image generation model 750. In one aspect, data preparation component 745 obtains a training set including a set of training images depicting an object with a set of values of a continuous attribute, respectively. In some examples, data preparation component 745 renders the set of training images based on a 3D model of the object.

According to some aspects, training image generation model 750 is implemented as software stored in memory unit 715 and executable by processor unit 705, as firmware, as one or more hardware circuits, or as a combination thereof. According to some embodiments, training image generation model 750 is implemented as software stored in a memory unit and executable by a processor in a processor unit of a separate computing device, as firmware in a separate computing device, as one or more hardware circuits of the separate computing device, or as a combination thereof. In some examples, training image generation model 750 is part of another apparatus other than image processing apparatus 700 and communicates with the image processing apparatus 700. In some examples, training image generation model 750 is part of image processing apparatus 700.

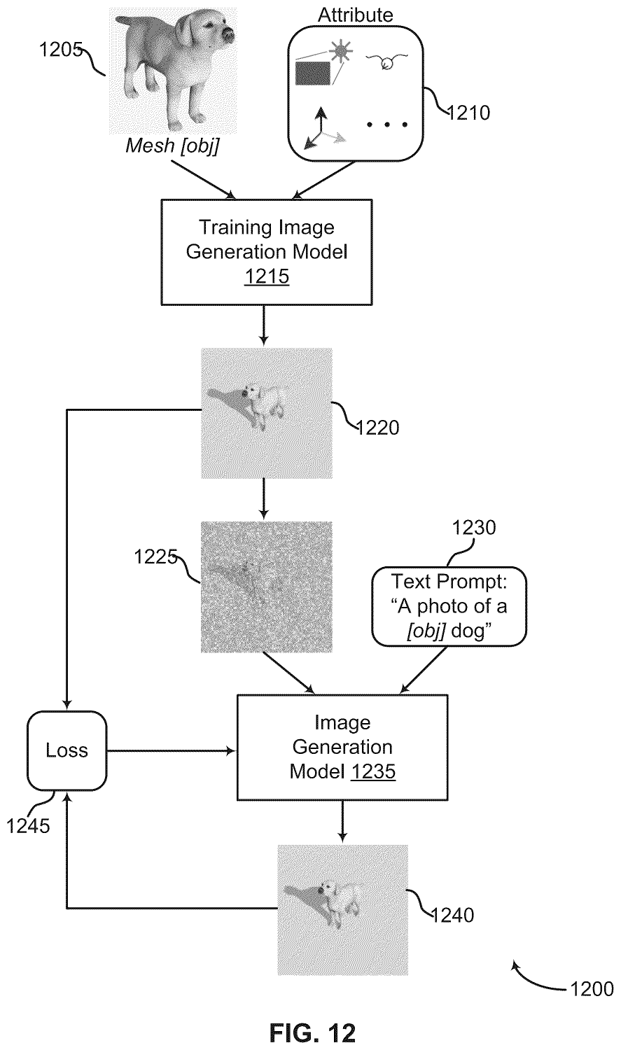

According to some aspects, training image generation model 750 generates a training image based on a 3D model of the object. Training image generation model 750 is an example of, or includes aspects of, the corresponding element described with reference to FIGS. 12 and 13. In some embodiments, training image generation model 750 includes a 3D render. In some embodiments, training image generation model 750 includes a ControlNet.

According to some aspects, training component 755 is implemented as software stored in memory unit 715 and executable by processor unit 705, as firmware, as one or more hardware circuits, or as a combination thereof. According to some embodiments, training component 755 is implemented as software stored in a memory unit and executable by a processor in a processor unit of a separate computing device, as firmware in a separate computing device, as one or more hardware circuits of the separate computing device, or as a combination thereof. In some examples, training component 755 is part of another apparatus other than image processing apparatus 700 and communicates with the image processing apparatus 700. In some examples, training component 755 is part of image processing apparatus 700.

According to some aspects, training component 755 initializes a machine learning model 720. In some examples, training component 755 trains, using the training set, an image generation model 740 to generate synthetic images with the set of values of the continuous attribute. In some examples, training component 755 trains, using the training set, a continuous control model 730 to generate an input for the image generation model 740 corresponding to the continuous attribute.

In some examples, training component 755 computes a reconstruction loss based on the training set. In some examples, training component 755 updates parameters of the image generation model 740 and parameters of the continuous control model 730 based on the reconstruction loss.

FIG. 8 shows an example of a machine learning model 800 according to aspects of the present disclosure. The example shown includes machine learning model 800, text prompt 805, text embedding model 810, text embedding 815, attribute 820, continuous control model 825, attribute embedding 830, text encoder 835, guidance feature 840, noise input 845, image generation model 850, synthetic image 855, and negative prompt 860.

Referring to FIG. 8, machine learning model 800 generates synthetic image 855 based on text prompt 805 and attribute 820. In some cases, synthetic image 855 includes an element described by text prompt 805 and a 3-dimensional characteristic from attribute 820. In some cases, for example, text prompt 805 states “A view of a chair in woods.” In some cases, text prompt 805 includes a nonce token in a region of a sequence of the text prompt 805. For example, the nonce token is represented as <V*>. For example, text prompt 805 states “A <V*> view of a chair in woods.” Text embedding model 810 receives text prompt 805 to generate text embedding 815. In some embodiments, text embedding model 810 divides text prompt 805 into a plurality of word tokens. In some aspects, text embedding 815 includes a table, where each cell of the table includes a word token of text prompt 805 in sequence.

According to some embodiments, continuous control model 825 receives attribute 820 to generate an attribute embedding 830. In some aspects, continuous control model 825 is trained using a continuous function, where continuous control model 825 is able to interpolate between two training data. For example, continuous control model 825 may receive a first value of attribute 820 and a second value of attribute 820 and continuous control model 825 is trained to generate intermediate values between the first value and the second value. Accordingly, continuous control model 825 can generate a continuous output.

In some cases, attribute 820 includes a 3-dimensional characteristic of the element described by the text prompt. For example, attribute 820 includes a plurality of values of the 3-dimensional orientation of the chair. In some cases, attribute 820 is integrated into a user control, where a value of attribute 820 can be easily modified using the user control. In some cases, for example, attribute embedding includes encoding of the semantic meaning of the 3-dimensional characteristic of attribute 820, where the encoding can be processed by machine learning model 800. In some embodiments, attribute embedding 830 is combined with text embedding 815 as input embedding to text encoder 835 of image generation model 850. For example, attribute embedding 830 is added to a region of a sequence of text embedding 815.

In some embodiments, text encoder 835 receives text embedding 815 (including attribute embedding 830) to generate guidance feature 840 for image generation model 850. For example, guidance feature 840 is used to guide the diffusion process in image generation model 850. In some cases, guidance feature 840 is a text embedding of text prompt 805 and attribute 820. In some embodiments, noise input 845 and guidance feature 840 are provided to image generation model 850 to generate synthetic image 855. In some cases, noise input 845 is a noise map. In some cases, noise input 845 includes a noisy image obtained by a noise map and a training image. Image generation model 850 performs a diffusion process on noise input 845 to obtain synthetic image 855.

In some embodiments, image generation model 850 further receives negative prompt 860 to generate synthetic image 855. For example, negative prompt 860 is used to guide image generation model 850 away from generating the element described by negative prompt 860. For example, negative prompt 860 includes elements depicted in the training images. In one embodiment, negative prompt 860 is provided to text encoder 835 to generate a negative prompt embedding, where guidance feature 840 includes the negative prompt embedding.

Machine learning model 800 is an example of, or includes aspects of, the corresponding element described with reference to FIGS. 3, 4, 5, 7, 12, and 13. Text prompt 805 is an example of, or includes aspects of, the corresponding element described with reference to FIGS. 3-5, 9, 12, and 13. Text embedding model 810 is an example of, or includes aspects of, the corresponding element described with reference to FIG. 7.

Text embedding 815 is an example of, or includes aspects of, the corresponding element described with reference to FIG. 13. Attribute 820 is an example of, or includes aspects of, the corresponding element described with reference to FIGS. 3, 12, and 13. Continuous control model 825 is an example of, or includes aspects of, the corresponding element described with reference to FIGS. 7 and 13.

Text encoder 835 is an example of, or includes aspects of, the corresponding element described with reference to FIGS. 7 and 9. Guidance feature 840 is an example of, or includes aspects of, the corresponding element described with reference to FIG. 9. Image generation model 850 is an example of, or includes aspects of, the corresponding element described with reference to FIGS. 4, 7, 12, and 13. Synthetic image 855 is an example of, or includes aspects of, the corresponding element described with reference to FIGS. 3, 4, 12, and 13.

FIG. 9 shows an example of a diffusion model 900 according to aspects of the present disclosure. The example shown includes diffusion model 900, original image 905, pixel space 910, image encoder 915, original image feature 920, latent space 925, forward diffusion process 930, noisy feature 935, reverse diffusion process 940, denoised image feature 945, image decoder 950, output image 955, text prompt 960, text encoder 965, guidance feature 970, and guidance space 975.

Diffusion models are a class of generative neural networks that can be trained to generate new data with features similar to features found in training data. In particular, diffusion models can be used to generate novel images. Diffusion models can be used for various image generation tasks including image super-resolution, generation of images with perceptual metrics, conditional generation (e.g., generation based on text guidance, color guidance, style guidance, and image guidance), image inpainting, and image manipulation.

Types of diffusion models include Denoising Diffusion Probabilistic Models (DDPMs) and Denoising Diffusion Implicit Models (DDIMs). In DDPMs, the generative process includes reversing a stochastic Markov diffusion process. DDIMs, on the other hand, use a deterministic process so that the same input results in the same output. Diffusion models may also be characterized by whether the noise is added to the image itself, or to image features generated by an encoder (e.g., latent diffusion).

Diffusion models work by iteratively adding noise to the data during a forward process and then learning to recover the data by denoising the data during a reverse process. For example, during training, diffusion model 900 may take an original image 905 in a pixel space 910 as input and apply an image encoder 915 to convert original image 905 into original image feature 920 in a latent space 925. Then, a forward diffusion process 930 gradually adds noise to the original image feature 920 to obtain noisy feature 935 (also in latent space 925) at various noise levels.

Next, a reverse diffusion process 940 (e.g., a U-Net ANN) gradually removes the noise from the noisy feature 935 at the various noise levels to obtain the denoised image feature 945 in latent space 925. In some examples, denoised image feature 945 is compared to the original image feature 920 at each of the various noise levels, and parameters of the reverse diffusion process 940 of the diffusion model are updated based on the comparison. Finally, an image decoder 950 decodes the denoised image feature 945 to obtain an output image 955 in pixel space 910. In some cases, an output image 955 is created at each of the various noise levels. The output image 955 can be compared to the original image 905 to train the reverse diffusion process 940. In some cases, output image 955 refers to the synthetic image (e.g., described with reference to FIGS. 3, 4, 5, 8, 12, and 13).

In some cases, image encoder 915 and image decoder 950 are pre-trained prior to training the reverse diffusion process 940. In some examples, image encoder 915 and image decoder 950 are trained jointly, or the image encoder 915 and image decoder 950 are fine-tuned jointly with the reverse diffusion process 940.

The reverse diffusion process 940 can also be guided based on a text prompt 960 or another guidance prompt, such as an image, a layout, a style, a color, a segmentation map, etc. The text prompt 960 can be encoded using a text encoder 965 (e.g., a multimodal encoder) to obtain guidance feature 970 in guidance space 975. The guidance feature 970 can be combined with the noisy feature 935 at one or more layers of the reverse diffusion process 940 to ensure that the output image 955 includes content described by the text prompt 960. For example, guidance feature 970 can be combined with the noisy feature 935 using a cross-attention block within the reverse diffusion process 940. In some cases, text prompt 960 refers to the corresponding element described with reference to FIGS. 3, 4, 5, 8, 12, and 13.

Cross-attention, also known as multi-head attention, is an extension of the attention mechanism used in some ANNs, for example, for NLP tasks. In some cases, cross-attention attends to multiple parts of an input sequence simultaneously, capturing interactions and dependencies between different elements. In cross-attention, there are two input sequences: a query sequence and a key-value sequence. The query sequence represents the elements that require attention, while the key-value sequence contains the elements to attend to. In some cases, to compute cross-attention, the cross-attention block transforms (for example, using linear projection) each element in the query sequence into a “query” representation, while the elements in the key-value sequence are transformed into “key” and “value” representations.

The cross-attention block calculates attention scores by measuring the similarity between each query representation and the key representations, where a higher similarity indicates that more attention is given to a key element. An attention score indicates an importance or relevance of each key element to a corresponding query element.

The cross-attention block then normalizes the attention scores to obtain attention weights (for example, using a softmax function), where the attention weights determine how much information from each value element is incorporated into the final attended representation. By attending to different parts of the key-value sequence simultaneously, the cross-attention block captures relationships and dependencies across the input sequences, allowing the machine learning model to understand the context and generate more accurate and contextually relevant outputs.

In some examples, diffusion models are based on a neural network architecture known as a U-Net. The U-Net takes input features having an initial resolution and an initial number of channels, and processes the input features using an initial neural network layer (e.g., a convolutional network layer) to generate intermediate features. The intermediate features are then down-sampled using a down-sampling layer such that down-sampled features have a resolution less than the initial resolution and a number of channels greater than the initial number of channels.

This process is repeated multiple times, and then the process is reversed. For example, the down-sampled features are up-sampled using the up-sampling process to obtain up-sampled features. The up-sampled features can be combined with intermediate features having a same resolution and number of channels via a skip connection. These inputs are processed using a final neural network layer to produce output features. In some cases, the output features have the same resolution as the initial resolution and the same number of channels as the initial number of channels.

In some cases, a U-Net takes additional input features to produce conditionally generated output. For example, the additional input features may include a vector representation of an input prompt. The additional input features can be combined with the intermediate features within the neural network at one or more layers. For example, a cross-attention module can be used to combine the additional input features and the intermediate features.

A diffusion process may also be modified based on conditional guidance. In some cases, a user provides a text prompt (e.g., text prompt 960) describing content to be included in a generated image. For example, a user may provide the prompt “A view of a chair in woods” In some examples, guidance can be provided in a form other than text, such as via an image, a sketch, a color, a style, or a layout. The system converts text prompt 960 (or other guidance) into a conditional guidance vector or other multi-dimensional representation. For example, text may be converted into a vector or a series of vectors using a transformer model, or a multi-modal encoder. In some cases, the encoder for the conditional guidance is trained independently of the diffusion model.

A noise map is initialized that includes random noise. The noise map may be in a pixel space or a latent space. By initializing an image with random noise, different variations of an image including the content described by the conditional guidance can be generated. Then, the diffusion model 900 generates an image based on the noise map and the conditional guidance vector.

A diffusion process can include both a forward diffusion process 930 for adding noise to an image (e.g., original image 905) or features (e.g., original image feature 920) in a latent space 925 and a reverse diffusion process 940 for denoising the images (or features) to obtain a denoised image (e.g., output image 955). The forward diffusion process 930 can be represented as q(xₜ|xₜ₋₁), and the reverse diffusion process 940 can be represented as p(xₜ₋₁|xₜ). In some cases, the forward diffusion process 930 is used during training to generate images with successively greater noise, and a neural network is trained to perform the reverse diffusion process 940 (e.g., to successively remove the noise).

In an example forward diffusion process 930 for a latent diffusion model (e.g., diffusion model 900), the diffusion model 900 maps an observed variable x₀ (either in a pixel space 910 or a latent space 925) intermediate variables x₁, . . . , x_{T} using a Markov chain. The Markov chain gradually adds Gaussian noise to the data to obtain the approximate posterior q(x_{1:T}|x₀) as the latent variables are passed through a neural network such as a U-Net, where x₁, . . . , x_{T} have the same dimensionality as x₀.

The neural network may be trained to perform the reverse diffusion process 940. During the reverse diffusion process 940, the diffusion model 900 begins with noisy data x_{T}, such as a noisy image and denoises the data to obtain the p(xₜ₋₁|xₜ). At each step t-1, the reverse diffusion process 940 takes xₜ, such as the first intermediate image, and t as input. Here, t represents a step in the sequence of transitions associated with different noise levels, The reverse diffusion process 940 outputs xₜ₋₁, such as the second intermediate image iteratively until x_{T} is reverted back to x₀, the original image 905. The reverse diffusion process 940 can be represented as:

$${p}_{θ} ( {x}_{t - 1} \vert {x}_{t} ) := N ( {x}_{t - 1} ; {μ}_{θ} ( {x}_{t} , t ) , {\sum }_{θ} ( {x}_{t} , t ) ) . \qquad ( 1 )$$

The joint probability of a sequence of samples in the Markov chain can be written as a product of conditionals and the marginal probability:

$${x}_{T} : {p}_{θ} ( {x}_{0 : T} ) := p ( {x}_{T} ) {\prod }_{t = 1}^{T} {p}_{θ} ( {x}_{t - 1} \vert {x}_{t} ) , \qquad ( 2 )$$

where p(x_{T})=N(x_{T}; 0, I) is the pure noise distribution as the reverse diffusion process 940 takes the outcome of the forward diffusion process 930, a sample of pure noise, as input and πₜ₌₁^{T}p_{θ}(xₜ₋₁|xₜ) represents a sequence of Gaussian transitions corresponding to a sequence of addition of Gaussian noise to the sample.

At interference time, observed data x₀ in a pixel space can be mapped into a latent space 925 as input and a generated data \tilde{x} is mapped back into the pixel space 910 from the latent space 925 as output. In some examples, x₀ represents an original input image with low image quality, latent variables x₁, . . . , x_{T} represent noisy images, and z represents the generated image with high image quality.

A diffusion model 900 may be trained using both a forward diffusion process 930 and a reverse diffusion process 940. In one example, the user initializes an untrained model. Initialization can include defining the architecture of the model and establishing initial values for the model parameters. In some cases, the initialization can include defining hyper-parameters such as the number of layers, the resolution and channels of each layer block, the location of skip connections, and the like.

The system then adds noise to a training image using a forward diffusion process 930 in N stages. In some cases, the forward diffusion process 930 is a fixed process where Gaussian noise is successively added to an image. In latent diffusion models, the Gaussian noise may be successively added to features (e.g., original image feature 920) in a latent space 925.

At each stage n, starting with stage N, a reverse diffusion process 940 is used to predict the image or image features at stage n-1. For example, the reverse diffusion process 940 can predict the noise that was added by the forward diffusion process 930, and the predicted noise can be removed from the image to obtain the predicted image. In some cases, an original image 905 is predicted at each stage of the training process.

The training component (e.g., training component described with reference to FIG. 7) compares predicted image (or image features) at stage n-1 to an actual image (or image features), such as the image at stage n-1 or the original input image. For example, given observed data x, the diffusion model 900 may be trained to minimize the variational upper bound of the negative log-likelihood −log p_{θ}(x) of the training data. The training component then updates parameters of the diffusion model 900 based on the comparison. For example, parameters of a U-Net may be updated using gradient descent. Time-dependent parameters of the Gaussian transitions can also be learned.

Text prompt 960 is an example of, or includes aspects of, the corresponding element described with reference to FIGS. 3-5, 8, 12, and 13. Text encoder 965 is an example of, or includes aspects of, the corresponding element described with reference to FIGS. 7 and 8. Guidance feature 970 is an example of, or includes aspects of, the corresponding element described with reference to FIG. 8.

FIG. 10 shows an example of a method 1000 for generating a synthetic image based on an embedding according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 1005, the system divides a text prompt into a set of tokens. In some cases, the operations of this step refer to, or may be performed by, a text embedding model as described with reference to FIGS. 7 and 8. In some cases, the text embedding model divides the text prompt into a plurality of word tokens.

At operation 1010, the system embeds each of the set of tokens to obtain a text embedding. In some cases, the operations of this step refer to, or may be performed by, a text embedding model as described with reference to FIGS. 7 and 8. In some cases, the text embedding includes a lookup table, where each cell of the table includes a word token of the text prompt in sequence.

At operation 1015, the system encodes the text embedding and an attribute embedding of a continuous attribute to obtain guidance information for an image generation model, where a synthetic image is generated based on the guidance information. In some cases, the operations of this step refer to, or may be performed by, a text encoder as described with reference to FIGS. 7-9. For example, the guidance information is used to guide the diffusion process in the image generation model. In some cases, the guidance information is a text embedding of the text prompt and the attribute. In some embodiments, a noise input and the guidance information are provided to the image generation model to generate the synthetic image.

### Training and Evaluation

In FIGS. 11-13, a method, apparatus, non-transitory computer readable medium, and system for image processing include initializing a machine learning model, obtaining a training set including a plurality of training images depicting an object with a plurality of values of a continuous attribute, respectively, training, using the training set, an image generation model to generate synthetic images with the plurality of values of the continuous attribute, and training, using the training set, a continuous control model to generate an input for the image generation model corresponding to the continuous attribute.

Some examples of the method, apparatus, non-transitory computer readable medium, and system further include rendering the plurality of training images based on a 3D model of the object. Some examples of the method, apparatus, non-transitory computer readable medium, and system further include generating, using a training image generation model, a training image based on a 3D model of the object.

In some aspects, the image generation model is trained individually in a first stage. In some aspects, the image generation model is trained together with the continuous control model in a second stage. Some examples of the method, apparatus, non-transitory computer readable medium, and system further include computing a reconstruction loss based on the training set. Some examples further include updating parameters of the image generation model and parameters of the continuous control model based on the reconstruction loss.

FIG. 11 shows an example of a method 1100 for training a machine learning model according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 1105, the system initializes a machine learning model. In some cases, the operations of this step refer to, or may be performed by, a training component as described with reference to FIG. 7. In some cases, initialization can include defining the architecture of the machine learning model and establishing initial values for the model parameters. In some cases, the initialization can include defining hyper-parameters such as the number of layers, the resolution and channels of each layer block, the location of skip connections, and the like.

At operation 1110, the system obtains a training set including a set of training images depicting an object with a set of values of a continuous attribute, respectively. In some cases, the operations of this step refer to, or may be performed by, a data preparation component as described with reference to FIG. 7. In some cases, obtaining a training set includes creating the training set using a data preparation component. For example, the data preparation component obtains an image/that includes objects O from category C as a function of several attributes l=f(a₁, a₂, a₃, . . . , aₙ), where aᵢ belongs to a set of image attributes A: shape, material reflectivity, rotation/translation, camera intrinsic/extrinsic, shape deformations, etc. In some embodiments, an attribute a is controlled by using a rendering engine to generate training images having an attribute value a=x. In addition, a token Tₓ is assigned to an identified image with the same attribute value. In some aspects, the attribute a is continuous and has multiple values, where the image generation model is trained using the tokens and corresponding attribute values to have fine-grained control over the attributes. In some cases, the training image generation model includes a 3D renderer that generates training images based on 3D data of an object and a plurality of continuous attributes.

In some embodiments, the training set is augmented to prevent the fine-tuning process from overfitting to simple white backgrounds and pre-defined object textures. For example, a training image generation model is used to augment the backgrounds and textures of the training images in the rendering process (e.g., generation of training images). In some embodiments, a ControlNet is used to generate augmented training images. In some cases, when an attribute reflects on shape changes (e.g., wing pose), the training image generation model uses the ground-truth depth maps as conditioning for ControlNet to generate the augmented training images. In some cases, when an attribute cannot reflect from depth maps (e.g., illumination), the training image generation model generates a preliminary training image without texture and uses a line-art extractor to obtain a sketch of the preliminary training image. The sketch of the preliminary training image captures features such as shades and shadows in pixel space, which can be used as conditioning for ControlNet to generate the augmented training images.

In some embodiments, additional prompts describing object appearance and background are provided to ControlNet to generate the augmented training images. In some cases, the additional prompts are simple and short. In some embodiments, the training set includes the training images and the augmented training images. For example, the training set includes a subset of the augmented training images. In some cases, the additional prompts are used to guide the image generation model in the second stage training.

At operation 1115, the system trains, using the training set, an image generation model to generate synthetic images with the set of values of the continuous attribute. In some cases, the operations of this step refer to, or may be performed by, a training component as described with reference to FIG. 7. For example, the image generation model is trained to generate synthetic images depicting the element described by the text prompt and a 3-dimensional characteristic from the attribute input (e.g., the continuous attribute). Further detail on training the image generation model is described with reference to FIGS. 12 and 13.

At operation 1120, the system trains, using the training set, a continuous control model to generate an input for the image generation model corresponding to the continuous attribute. In some cases, the operations of this step refer to, or may be performed by, a training component as described with reference to FIG. 7. For example, the continuous control model is trained to generate an attribute embedding based on the attribute input, where the attribute embedding is added to the text embedding of the text prompt as input to the image generation model. Further detail on training the continuous control model is described with reference to FIGS. 12 and 13.

FIG. 12 shows an example of a first stage training according to aspects of the present disclosure. The example shown includes machine learning model 1200, training data 1205, attribute 1210, training image generation model 1215, training image 1220, noisy image 1225, text prompt 1230, image generation model 1235, synthetic image 1240, and loss 1245.

Referring to FIG. 12, machine learning model 1200 is fine-tuned using loss 1245 during the first stage training. For example, machine learning model 1200 obtains a training set including training data 1205 and attribute 1210. In one aspect, training data 1205 includes 3D data points (or mesh) of an object, for example, the dog. In one aspect, attribute 1210 includes a 3-dimensional characteristic of the object such as, for example, 3-dimensional orientation, illumination direction, wing pose, etc. Using training data 1205 and attribute 1210, training image generation model 1215 is used to generate training image 1220 depicting the dog from training data 1205 and a 3-dimensional characteristic from attribute 1210. In one aspect, training image generation model 1215 includes a 3D renderer that generates images (e.g., training image 1220) based on the mesh (e.g., training data 1205).

According to some embodiments, image generation model 1235 is fine-tuned using loss 1245. For example, machine learning model 1200 applies a noise map to training image 1220 to obtain noisy image 1225. Image generation model 1235 receives noisy image 1225 and text prompt 1230 to generate synthetic image 1240. For example, text prompt 1230 states “A photo of a [obj] dog.” In one aspect, [obj] represents the identity of the dog from training data 1205. By training image generation model 1235 using the identifier [obj], image generation model 1235 is trained to preserve and learn the identity of the dog to be generated in synthetic image 1240. In some embodiments, loss 1245 is computed based on synthetic image 1240 and training image 1220. For example, loss 1245 includes a reconstruction loss. In some aspects, the training loss (e.g., loss 1245) is represented as:

$$arg {min}_{θ , Φ} {𝔼}_{{\hat{I}}_{∈ , a} , a} [ {‖ {S}_{θ} ( {\hat{I}}_{∈ , a} , P ( {g}_{Φ} ( a ) ) ) - {I}_{a} ‖}_{2}^{2} ] , \qquad ( 3 )$$

where I_{O} represents training image 1220 depicting attribute a, Î_{∈,a} represents noisy image 1225 with noise ∈, and P(g_{Φ}(a)) represents prompt of attribute a.

Machine learning model 1200 is an example of, or includes aspects of, the corresponding element described with reference to FIGS. 3, 4, 5, 7, 8, and 13. Training data 1205 is an example of, or includes aspects of, the corresponding element described with reference to FIG. 13. Attribute 1210 is an example of, or includes aspects of, the corresponding element described with reference to FIGS. 3, 8, and 13.

Training image generation model 1215 is an example of, or includes aspects of, the corresponding element described with reference to FIGS. 7 and 13. Training image 1220 is an example of, or includes aspects of, the corresponding element described with reference to FIG. 13. Noisy image 1225 is an example of, or includes aspects of, the corresponding element described with reference to FIG. 13.

Text prompt 1230 is an example of, or includes aspects of, the corresponding element described with reference to FIGS. 3-5, 8, 9, and 13. Image generation model 1235 is an example of, or includes aspects of, the corresponding element described with reference to FIGS. 4, 7, 8, and 13. Synthetic image 1240 is an example of, or includes aspects of, the corresponding element described with reference to FIGS. 3, 4, 8, and 13. Loss 1245 is an example of, or includes aspects of, the corresponding element described with reference to FIG. 13.

FIG. 13 shows an example of a second stage training according to aspects of the present disclosure. The example shown includes machine learning model 1300, training data 1305, attribute 1310, training image generation model 1315, training image 1320, noisy image 1325, continuous control model 1330, text prompt 1335, text embedding 1340, image generation model 1345, synthetic image 1350, and loss 1355.

Referring to FIG. 13, machine learning model 1300 is fine-tuned using loss 1355 during the second stage training. For example, machine learning model 1300 obtains a training set including training data 1305 and attribute 1310. In one aspect, training data 1205 includes 3D data points (or mesh) of an object, for example, a dog. In one aspect, attribute 1310 includes a 3-dimensional characteristic of the object such as, for example, 3-dimensional orientation, illumination direction, wing pose, etc. Using training data 1305 and attribute 1310, training image generation model 1315 is used to generate training image 1320 depicting the dog from training data 1305 and a 3-dimensional characteristic from attribute 1310. In one aspect, training image generation model 1315 includes a 3D renderer that generates images (e.g., training image 1320) based on the mesh (e.g., training data 1305). In one aspect, training image generation model 1315 includes a ControlNet that generates training image 1320 based on training data 1305 and attribute 1310.

According to some embodiments, continuous control model 1330 generates an attribute embedding based on attribute 1310. In one aspect, machine learning model 1300 encodes text prompt 1335 to obtain text embedding 1340. In some embodiments, the attribute embedding is combined with text embedding 1340 as input to image generation model 1345. For example, image generation model 1345 receives noisy image 1325 (for example, obtained from training image 1320) and text embedding 1340 (for example, obtained from attribute 1310 and text prompt 1335) to generate synthetic image 1350. In some cases, image generation model 1345 performs a diffusion process (e.g., the reverse diffusion process described with reference to FIG. 9) on noisy image 1325 to generate synthetic image 1350.

In some embodiments, machine learning model 1300 (including image generation model 1345 and continuous control model 1330) is trained based on a continuous function g_{Φ}(a): D→T, which maps a set of attributes from the continuous domain D to the token embedding domain T. In some embodiments, machine learning model 1300 uses positional encoding to cast each attribute a ∈a to a high-frequency space before providing the attribute to the continuous function. For example, the attributes (e.g., attribute 1310) are provided to continuous control model 1330, which includes a 2-layer multilayer perceptron (MLP), to generate the attribute embedding. By transforming the attributes to a high-frequency space, machine learning model 1300 enables a user to easily control continuous attributes from text prompt 1335 augmented by the token embedding (e.g., the attribute embedding).

In some embodiments, image generation model 1345 is fine-tuned using loss 1355 computed based on synthetic image 1350 and training image 1320. For example, loss 1355 includes a reconstruction loss. In some aspects, the training loss (e.g., loss 1355) is represented as:

$$arg {min}_{θ , Φ} {𝔼}_{{\hat{I}}_{∈ , a} , a} [ {‖ {S}_{θ} ( {\hat{I}}_{∈ , a} , P ( {T}_{O} , {g}_{Φ} ( a ) ) ) - {I}_{a} ‖}_{2}^{2} ] , \qquad ( 4 )$$

where T_{O} represents the conditioning of text prompt 1335 depicting object O. According to some aspects, for every image in I_{O} with varying attribute a, machine learning model 1300 associates the same prompt conditioning P(T_{O}) to the same object O and train model parameter θ of image generation model 1345 and continuous control model g_{Φ} using the prompt condition P(T_{O}, g_{Φ}(a)) (e.g., text embedding 1340 including the text embedding of text prompt 1335 and attribute embedding of attribute 1310). Accordingly, machine learning model 1300 can be trained to generate synthetic image 1350 depicting the element described by text prompt 1335 and attribute 1310.

Machine learning model 1300 is an example of, or includes aspects of, the corresponding element described with reference to FIGS. 3, 4, 5, 7, 8, and 12. Training data 1305 is an example of, or includes aspects of, the corresponding element described with reference to FIG. 12. Attribute 1310 is an example of, or includes aspects of, the corresponding element described with reference to FIGS. 3, 8, and 12.

Training image generation model 1315 is an example of, or includes aspects of, the corresponding element described with reference to FIGS. 7 and 12. Training image 1320 is an example of, or includes aspects of, the corresponding element described with reference to FIG. 12. Noisy image 1325 is an example of, or includes aspects of, the corresponding element described with reference to FIG. 12.

Continuous control model 1330 is an example of, or includes aspects of, the corresponding element described with reference to FIGS. 7 and 8. Text prompt 1335 is an example of, or includes aspects of, the corresponding element described with reference to FIGS. 3-5, 8, 9, and 12. Text embedding 1340 is an example of, or includes aspects of, the corresponding element described with reference to FIG. 8.

Image generation model 1345 is an example of, or includes aspects of, the corresponding element described with reference to FIGS. 4, 7, 8, and 12. Synthetic image 1350 is an example of, or includes aspects of, the corresponding element described with reference to FIGS. 3, 4, 8, and 12. Loss 1355 is an example of, or includes aspects of, the corresponding element described with reference to FIG. 12.

### Commuting Device

FIG. 14 shows an example of a computing device 1400 according to aspects of the present disclosure. The example shown includes computing device 1400, processor 1405, memory subsystem 1410, communication interface 1415, I/O interface 1420, user interface component 1425, and channel 1430.

In some embodiments, computing device 1400 is an example of, or includes aspects of, the image processing apparatus described with reference to FIGS. 1 and 7. In some embodiments, computing device 1400 includes processor 1405 that can execute instructions stored in memory subsystem 1410 to obtain a text prompt describing an element and an attribute value for a continuous attribute of the element, embed the text prompt to obtain a text embedding in a text embedding space, embed the attribute value to obtain an attribute embedding in the text embedding space, and generate a synthetic image based on the text embedding and the attribute embedding, where the synthetic image depicts the continuous attribute of the element based on the attribute value.

According to some embodiments, processor 1405 includes one or more processors. In some cases, processor 1405 is an intelligent hardware device, (e.g., a general-purpose processing component, a digital signal processor (DSP), a central processing unit (CPU), a graphics processing unit (GPU), a microcontroller, an application-specific integrated circuit (ASIC), a field programmable gate array (FPGA), a programmable logic device, a discrete gate or transistor logic component, a discrete hardware component, or a combination thereof. In some cases, processor 1405 is configured to operate a memory array using a memory controller. In other cases, a memory controller is integrated into processor 1405. In some cases, processor 1405 is configured to execute computer-readable instructions stored in a memory to perform various functions. In some embodiments, processor 1405 includes special-purpose components for modem processing, baseband processing, digital signal processing, or transmission processing. Processor 1405 is an example of, or includes aspects of, the processor unit described with reference to FIG. 7.

According to some embodiments, memory subsystem 1410 includes one or more memory devices. Examples of a memory device include random access memory (RAM), read-only memory (ROM), or a hard disk. Examples of memory devices include solid-state memory and a hard disk drive. In some examples, memory is used to store computer-readable, computer-executable software including instructions that, when executed, cause a processor to perform various functions described herein. In some cases, the memory contains, among other things, a basic input/output system (BIOS) that controls basic hardware or software operations such as the interaction with peripheral components or devices. In some cases, a memory controller operates memory cells. For example, the memory controller can include a row decoder, column decoder, or both. In some cases, memory cells within a memory store information in the form of a logical state. Memory subsystem 1410 is an example of, or includes aspects of, the memory unit described with reference to FIG. 7.

According to some embodiments, communication interface 1415 operates at a boundary between communicating entities (such as computing device 1400, one or more user devices, a cloud, and one or more databases) and channel 1430 and can record and process communications. In some cases, communication interface 1415 is provided to enable a processing system coupled to a transceiver (e.g., a transmitter and/or a receiver). In some examples, the transceiver is configured to transmit (or send) and receive signals for a communications device via an antenna. In some cases, a bus is used in communication interface 1415.

According to some embodiments, I/O interface 1420 is controlled by an I/O controller to manage input and output signals for computing device 1400. In some cases, I/O interface 1420 manages peripherals not integrated into computing device 1400. In some cases, I/O interface 1420 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 1420 or hardware components controlled by the I/O controller. I/O interface 1420 is an example of, or includes aspects of, the I/O module described with reference to FIG. 7.

According to some embodiments, user interface component 1425 enables a user to interact with computing device 1400. In some cases, user interface component 1425 includes an audio device, such as an external speaker system, an external display device such as a display screen, an input device (e.g., a remote-control device interfaced with a user interface directly or through the I/O controller), or a combination thereof.

The performance of apparatus, systems, and methods of the present disclosure have been evaluated, and results indicate embodiments of the present disclosure have obtained increased performance over existing technology (e.g., conventional image generation models). Example experiments demonstrate that the image processing apparatus based on the present disclosure outperforms conventional image generation models. Details on the example use cases based on embodiments of the present disclosure are described with reference to FIGS. 3, 4, and 5.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein, but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method comprising:
obtaining a text prompt describing an element and an attribute value for a continuous attribute of the element;
embedding the text prompt to obtain a text embedding in a text embedding space;
embedding, using a continuous control model, the attribute value to obtain an attribute embedding in the text embedding space; and
generating, using an image generation model, a synthetic image based on the text embedding and the attribute embedding, wherein the synthetic image depicts the continuous attribute of the element based on the attribute value.

2. The method of claim 1, wherein:
the continuous attribute comprises a 3-dimensional characteristic of the element.

3. The method of claim 1, wherein embedding the text prompt comprises:
dividing the text prompt into a plurality of tokens; and
embedding each of the plurality of tokens using a text embedding model.

4. The method of claim 1, wherein:
the text prompt includes a nonce token corresponding to the attribute value.

5. The method of claim 1, wherein:
the text prompt includes a word corresponding to the continuous attribute.

6. The method of claim 1, further comprising:
encoding the text embedding and the attribute embedding to obtain guidance information for the image generation model, wherein the synthetic image is generated based on the guidance information.

7. The method of claim 1, wherein generating the synthetic image comprises:
performing a diffusion process on a noise input to obtain the synthetic image.

8. The method of claim 1, wherein:
the image generation model is trained using a training set including a plurality of training images depicting an object with a plurality of values of the continuous attribute, respectively.

9. The method of claim 8, further comprising:
identifying a negative prompt based on the object from the plurality of training images, wherein the synthetic image is generated based on the negative prompt.

10. The method of claim 1, further comprising:
obtaining an additional attribute value corresponding to an additional continuous attribute, wherein the synthetic image is generated to depict the additional attribute value.

11. The method of claim 1, further comprising:
obtaining a plurality of attribute values for the continuous attribute; and
generating, using the image generation model, a plurality of synthetic images based on a same random input and the plurality of attribute values, respectively.

12. A method comprising:
initializing a machine learning model;
obtaining a training set including a plurality of training images depicting an object with a plurality of values of a continuous attribute, respectively;
training, using the training set, an image generation model to generate synthetic images with the plurality of values of the continuous attribute; and
training, using the training set, a continuous control model to generate an input for the image generation model corresponding to the continuous attribute.

13. The method of claim 12, wherein obtaining the training set comprises:
rendering the plurality of training images based on a 3D model of the object.

14. The method of claim 12, wherein obtaining the training set comprises:
generating, using a training image generation model, a training image based on a 3D model of the object.

15. The method of claim 12, wherein:
the image generation model is trained individually in a first stage, and the image generation model is trained together with the continuous control model in a second stage.

16. The method of claim 12, wherein training the image generation model comprises:
computing a reconstruction loss based on the training set; and
updating parameters of the image generation model and parameters of the continuous control model based on the reconstruction loss.

17. An apparatus comprising:
at least one processor;
at least one memory storing instructions executable by the at least one processor;
a continuous control model comprising parameters stored in the at least one memory and trained to embed an attribute value of a continuous attribute to obtain an attribute embedding in a text embedding space; and
an image generation model comprising parameters stored in the at least one memory and trained to generate a synthetic image based on a text embedding of a text prompt and the attribute embedding, wherein the synthetic image depicts the continuous attribute based on the attribute value.

18. The apparatus of claim 17, further comprising:
a text encoder comprising parameters stored in the at least one memory and configured to encode the text embedding and the attribute embedding to obtain guidance information for the image generation model.

19. The apparatus of claim 17, wherein:
the continuous control model comprises a multilayer perceptron (MLP).

20. The apparatus of claim 17, wherein:
the image generation model comprises a diffusion model.
